(19) United States
(12) Patent Application Publication
(10) Pub. No.: US 2025/0373781 A1
(43) Pub. Date: Dec. 4, 2025

(54) IMAGE PROCESSING APPARATUS, METHOD, AND PROGRAM

(71) Applicant: FUJIFILM Corporation, Tokyo (JP)

(72) Inventors: Kentaro MIYAMOTO, Saitama (JP); Yuki OKABE, Saitama (JP); Akiko FUKUSHIMA, Saitama (JP)

(73) Assignee: FUJIFILM Corporation, Tokyo (JP)

(21) Appl. No.: 19/212,630

(22) Filed: May 19, 2025

(30) Foreign Application Priority Data
May 29, 2024 (JP) 2024-087299

(51) Int. Cl. H04N 17/00; G06T 7/00

(52) U.S. Cl. CPC H04N 17/002; G06T 7/0002; G06T 2207/10016; G06T 2207/30168

(57) ABSTRACT

Provided are an image processing apparatus, a method, and a program that can easily check an imaging state of each camera in a case where imaging is performed by a plurality of cameras. The image processing apparatus that processes first images captured in time series by the plurality of cameras includes a processor. The processor acquires the first images, acquires first information related to imaging states of the first images, disposes the most recent N first images of the plurality of cameras in time series order in a case where N≥2 and generates a second image including second information indicating an imaging failure of the first image based on the first information, and outputs the second image to a display destination.

### CROSS-REFERENCE TO RELATED APPLICATION

The present application claims priority under 35 U.S.C § 119(a) to Japanese Patent Application No. 2024-087299 filed on May 29, 2024, which is hereby expressly incorporated by reference, in its entirety, into the present application.

### BACKGROUND OF THE INVENTION

### 1. Field of the Invention

The present invention relates to an image processing apparatus, a method, and a program and particularly to an image processing apparatus, a method, and a program for processing images captured by a plurality of cameras.

### 2. Description of the Related Art

JP2023-134182A discloses a technique of determining, for a plurality of images continuously captured while automatically moving an imaging apparatus, an imaging position of a failure image and automatically reproducing the imaging position to perform reimaging.

JP2003-259342A and JP2009-187388A disclose a technique of arranging images captured in time series by a plurality of cameras in time series order (in order of a captured time) for each camera.

### SUMMARY OF THE INVENTION

One embodiment according to the technique of the present disclosure provides an image processing apparatus, a method, and a program that can easily check an imaging state of each camera in a case of performing imaging with a plurality of cameras.
(1) An image processing apparatus that processes first images captured by a plurality of cameras in time series, the image processing apparatus comprising a processor,
in which the processor is configured to:
acquire the first images;
acquire first information related to imaging states of the first images;
dispose the most recent N first images of the plurality of cameras in time series order in a case where N≥2 and generate a second image including second information indicating an imaging failure of the first image based on the first information; and
output the second image to a display destination.
(2) The image processing apparatus according to (1),
in which the processor is configured to dispose the first images of the plurality of cameras side by side in a first direction and generate the second image in which the most recent N first images of the plurality of cameras are disposed side by side in the time series order in a second direction.
(3) The image processing apparatus according to (2),
in which the plurality of cameras are disposed in predetermined arrangement, and
the processor is configured to generate the second image in which the latest first images of the plurality of cameras are disposed side by side in the first direction in arrangement corresponding to the arrangement of the plurality of cameras.
(4) The image processing apparatus according to any one of (1) to (3),
in which the plurality of cameras are mounted on a moving object to move integrally and capture the first images with movement of the moving object.
(5) The image processing apparatus according to (4),
in which the processor is configured to:
acquire third information related to a position of the moving object; and
generate the second image further including the third information.
(6) The image processing apparatus according to (5),
in which the third information is information on a distance from a starting point.
(7) The image processing apparatus according to (5) or (6),
in which the second information includes information related to the position of the moving object at an imaging timing of the first image determined to be the imaging failure.
(8) The image processing apparatus according to any one of (1) to (7),
in which the processor is configured to generate the second image further including fourth information related to a dispositional relationship between the plurality of cameras.
(9) The image processing apparatus according to (8),
in which the fourth information is information on a figure in which a first symbol or a first figure indicating each of the cameras is disposed to correspond to disposition of the plurality of cameras.
(10) The image processing apparatus according to (8) or (9),
in which the fourth information further includes information on a figure indicating an outline of an imaging target.
(11) The image processing apparatus according to (9),
in which the processor is configured to highlight and display the first symbol or the first figure of the camera in which the imaging failure has occurred.
(12) The image processing apparatus according to any one of (1) to (11),
in which the processor is configured to dispose a second symbol or a second figure indicating each of the cameras and generate the second image in which the most recent N first images of the corresponding camera are disposed in the time series order in association with the second symbol or the second figure.
(13) The image processing apparatus according to (12),
in which the processor is configured to highlight and display the second symbol or the second figure of the camera in which the imaging failure has occurred.
(14) The image processing apparatus according to any one of (1) to (13),
in which the processor is configured to:
acquire fifth information related to states of the plurality of cameras; and
generate the second image further including the fifth information of the plurality of cameras.
(15) The image processing apparatus according to (14),
in which the fifth information includes information on a remaining battery level.
(16) The image processing apparatus according to (14) or (15),
in which the processor is configured to generate the second image in which the most recent N first images of the corresponding camera are disposed in the time series order in association with the fifth information of the plurality of cameras.
(17) The image processing apparatus according to any one of (1) to (16),
in which the processor is configured to generate the second image in which the most recent N first images of the plurality of cameras are disposed in the time series order with at least any one of a size or a tone changed.
(18) The image processing apparatus according to any one of (1) to (17),
in which the processor is configured to analyze the first images and acquire the first information.
(19) The image processing apparatus according to any one of (1) to (18),
in which the processor is configured to:
estimate a cause of the imaging failure based on the first information; and
generate the second image further including an estimation result of the cause of the imaging failure.
(20) An image processing method of processing first images captured by a plurality of cameras in time series, the image processing method comprising:
acquiring the first images;
acquiring first information related to imaging states of the first images;
disposing the most recent N first images of the plurality of cameras in time series order in a case where N≥2 and generating a second image including second information indicating an imaging failure of the first image based on the first information; and
outputting the second image to a display destination.
(21) An image processing program that processes first images captured by a plurality of cameras in time series, the image processing program causing a computer to realize:
a function of acquiring the first images;
a function of acquiring first information related to imaging states of the first images;
a function of disposing the most recent N first images of the plurality of cameras in time series order in a case where N≥2 and generating a second image including second information indicating an imaging failure of the first image based on the first information; and
a function of outputting the second image to a display destination.

### BRIEF DESCRIPTION OF THE DRAWINGS

FIG. 1 is a view showing a schematic configuration of an imaging system.

FIG. 2 is a perspective view showing a configuration of a multi-eye imaging apparatus.

FIG. 3 is a front view showing a configuration of the multi-eye imaging apparatus.

FIG. 4 is a side view showing a configuration of the multi-eye imaging apparatus.

FIG. 5 is a front view showing attachment states of cameras and illumination devices to a front panel.

FIG. 6 is a rear view showing the attachment states of the cameras and the illumination devices to the front panel.

FIG. 7 is a front view showing attachment states of cameras and illumination devices to a rear panel.

FIG. 8 is a rear view showing the attachment states of the cameras and the illumination devices to the rear panel.

FIG. 9 is a block diagram showing a system configuration of the imaging system.

FIG. 10 is a diagram showing an example of a hardware configuration of a control device.

FIG. 11 is a block diagram of main functions related to imaging control.

FIG. 12 is a block diagram of main functions related to presentation of an imaging status.

FIG. 13 is a block diagram of main functions of an image determination unit.

FIG. 14 is a view showing an example of an output image.

FIG. 15 is a view showing an example of the output image in a case where a problem has occurred in a camera.

FIG. 16 is an enlarged view of an image display region.

FIG. 17 is a view showing an example of display of the image display region in a case where an imaging failure has occurred.

FIGS. 18A to 18C are views showing a state of a change in a captured image display region with progress of imaging.

FIGS. 19A to 19C are views showing a state of a change in the captured image display region with progress of imaging.

FIG. 20 is a view showing an example of enlarged display.

FIG. 21 is a flowchart showing an example of a processing procedure of the control device in a case where imaging is automatically stopped.

FIG. 22 is a view showing another example of display of a captured image in the captured image display region.

FIG. 23 is a view showing still another example of the display of the captured image in the captured image display region.

FIG. 24 is a view showing still another example of the display of the captured image in the captured image display region.

FIG. 25 is a view showing an example of screen display of an error cause.

### DESCRIPTION OF THE PREFERRED EMBODIMENTS

Hereinafter, a preferred embodiment of the present invention will be described in detail in accordance with the accompanying drawings.

Herein, a case where the present invention is applied to an imaging system that images an inner wall surface of a tunnel structure for the purpose of inspection will be described as an example.

A tunnel structure (hereinafter, referred to as a “tunnel”), such as a water diversion channel of a hydroelectric power generation facility and a subway tunnel, is regularly inspected in order to ensure safety. In the related art, visual inspection has been general, but in recent years, inspection based on an image using a camera has been increasingly used instead. The inspection based on an image is performed by imaging the inner wall surface of the tunnel with a camera and detecting damage such as fissuring from the obtained image through visual inspection or image processing.

As an imaging apparatus suitable for imaging the inner wall surface of the tunnel, an apparatus (multi-eye imaging apparatus) which is on a moving object, on which a plurality of cameras are mounted, and which images while moving in the tunnel is known. The plurality of cameras are installed such that imaging ranges partially overlap between cameras adjacent to each other so that panorama composition can be performed after imaging.

In the inspection based on an image, it is necessary to image a target with high image quality (for example, image quality sufficient to check fissuring having a width of 0.2 mm) without omission, and in a case where the imaging fails, it is necessary to reimage. However, even in a case where an inside of the tunnel is dark and reimaging is performed, in some cases, it is difficult to immediately determine at which point to return to and the reimaging is performed.

In the present embodiment, an imaging system that can easily check an imaging state of each camera in a case where imaging is performed by a plurality of cameras while moving in the tunnel and that can easily perform reimaging even in a case where imaging fails is provided.

### Configuration of Imaging System

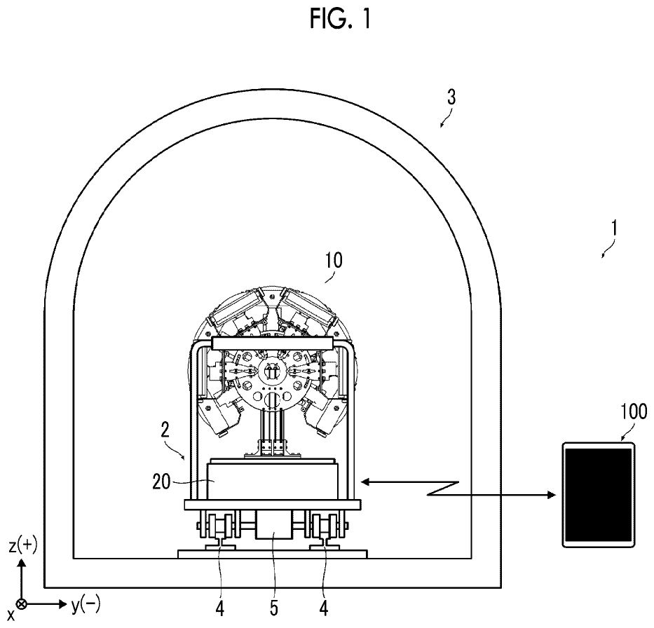

FIG. 1 is a view showing a schematic configuration of the imaging system.

As described above, an imaging system 1 of the present embodiment is composed of a system that images an inner wall surface of a tunnel 3 while moving in the tunnel 3. FIG. 1 shows an example of a case where the tunnel 3, which is an imaging target, is a so-called horseshoe-shaped tunnel (a tunnel of which a cross-sectional shape is a horseshoe shape).

As shown in FIG. 1, the imaging system 1 comprises a multi-eye imaging apparatus 10 that comprises a plurality of cameras and an illumination device and a control device 100 that controls the multi-eye imaging apparatus 10 and that processes an image captured by the multi-eye imaging apparatus 10.

The multi-eye imaging apparatus 10 is mounted on, for example, a hand-pushed cart 2 and moves in the tunnel 3. Accordingly, the plurality of cameras can be integrally moved. FIG. 1 shows an example of a case where a rail 4 is laid in the tunnel 3. In this case, for example, the cart 2 travels on the rail 4 and moves in the tunnel 3.

The cart 2 comprises a distance meter 5. The distance meter 5 measures a distance from a starting point to the current position (a distance along a route). In a case where the cart 2 travels on the rail 4, the distance is measured along the rail 4. The distance meter 5 measures the distance by using, for example, rotation of wheels of the cart 2.

Information on a distance measured by the distance meter 5 is transmitted to the control device 100 via a relay device 20. Therefore, the distance meter 5 has a communication function.

### Multi-Eye Imaging Apparatus

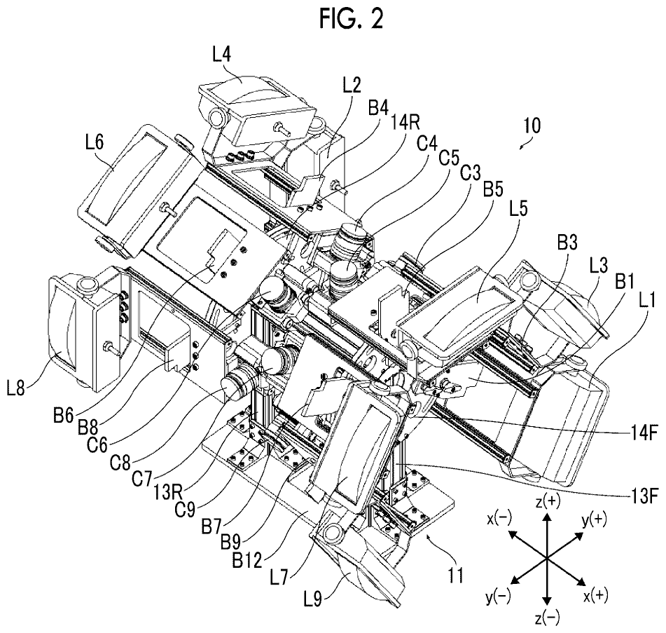

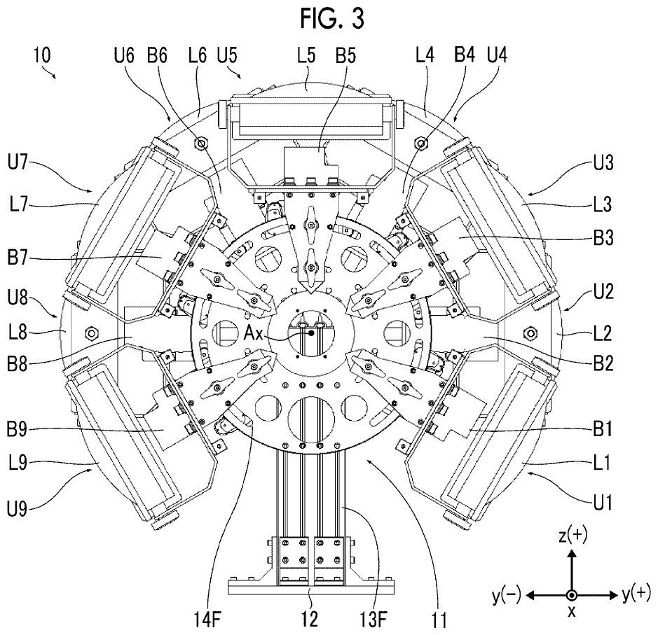

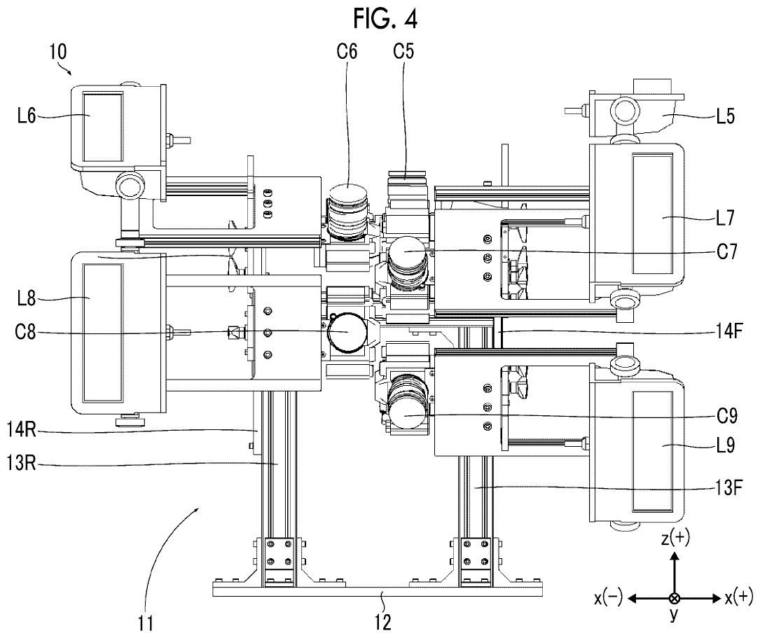

FIG. 2 is a perspective view showing a configuration of the multi-eye imaging apparatus. FIG. 3 is a front view showing the configuration of the multi-eye imaging apparatus. FIG. 4 is a side view showing the configuration of the multi-eye imaging apparatus. In FIGS. 2 to 4, x, y, and z are three axes orthogonal to each other. A plane including an x-axis and a y-axis is defined as a horizontal plane, and a direction of a z-axis is defined as a vertical direction. In addition, a direction of the x-axis is defined as a traveling direction of the cart 2, and a + direction of the x-axis (a right direction in FIG. 4) is defined as a progressing direction in a case of imaging. Therefore, the + direction of the x-axis (the right direction in FIG. 4) is a forward direction (advancing direction) of the cart 2 and the multi-eye imaging apparatus 10, and a − direction (a left direction in FIG. 4) is a rearward direction (retreating direction) of the cart 2 and the multi-eye imaging apparatus 10.

The multi-eye imaging apparatus 10 is configured by combining the plurality of cameras and a plurality of illumination devices. The number of cameras and the number of illumination devices are increased or decreased as appropriate according to an imaging target. Herein, a case where the multi-eye imaging apparatus 10 is configured using nine cameras C1 to C9 and nine illumination devices L1 to L9 will be described as an example.

The multi-eye imaging apparatus 10 has a frame 11 for attaching the plurality of cameras C1 to C9 and the plurality of illumination devices L1 to L9. The frame 11 is composed of a base 12, a front column 13F, a rear column 13R, a front panel 14F, a rear panel 14R, and the like.

The base 12 has a rectangular flat plate shape. The front column 13F and the rear column 13R are installed on the base 12.

The front column 13F and the rear column 13R have a prismatic shape. The front column 13F and the rear column 13R are disposed at a predetermined interval in a front-rear direction (the direction of the x-axis) with respect to the base 12. In addition, the front column 13F and the rear column 13R are installed vertically with respect to the base 12. The front panel 14F is attached to the front column 13F, and the rear panel 14R is attached to the rear column 13R.

The front panel 14F and the rear panel 14R have a disk-like shape. The front panel 14F and the rear panel 14R are disposed to be orthogonal to the front-rear direction (the direction of the x-axis) of the base 12 and are disposed to be coaxial with each other. An axis that passes through centers of the front panel 14F and the rear panel 14R and that is parallel to the x-axis is defined as an axis Ax of the multi-eye imaging apparatus 10.

The cameras C1 to C9 and the illumination devices L1 to L9 are attached to the front panel 14F or the rear panel 14R via brackets B1 to B9. Hereinafter, as necessary, the camera C1 will be referred to as a “first camera C1”, the camera C2 will be referred to as a “second camera C2”, the camera C3 will be referred to as a “third camera C3”, the camera C4 will be referred to as a “fourth camera C4”, the camera C5 will be referred to as a “fifth camera C5”, the camera C6 will be referred to as a “sixth camera C6”, the camera C7 will be referred to as a “seventh camera C7”, the camera C8 will be referred to as an “eighth camera C8”, and the camera C9 will be referred to as a “ninth camera C9” to distinguish the respective cameras C1 to C9. In addition, the illumination device L1 will be referred to as a “first illumination device L1”, the illumination device L2 will be referred to as a “second illumination device L2”, the illumination device L3 will be referred to as a “third illumination device L3”, the illumination device L4 will be referred to as a “fourth illumination device L4”, the illumination device L5 will be referred to as a “fifth illumination device L5”, the illumination device L6 will be referred to as a “sixth illumination device L6”, the illumination device L7 will be referred to as a “seventh illumination device L7”, the illumination device L8 will be referred to as an “eighth illumination device L8”, and the illumination device L9 will be referred to as a “ninth illumination device L9” to distinguish the respective illumination devices L1 to L9. In addition, the bracket B1 will be referred to as a “first bracket B1”, the bracket B2 will be referred to as a “second bracket B2”, the bracket B3 will be referred to as a “third bracket B3”, the bracket B4 will be referred to as a “fourth bracket B4”, the bracket B5 will be referred to as a “fifth bracket B5”, the bracket B6 will be referred to as a “sixth bracket B6”, the bracket B7 will be referred to as a “seventh bracket B7”, the bracket B8 will be referred to as an “eighth bracket B8”, and the bracket B9 will be referred to as a “ninth bracket B9” to distinguish the respective the brackets B1 to B9.

The first camera C1 and the first illumination device L1 are attached to the front panel 14F via the first bracket B1. The second camera C2 and the second illumination device L2 are attached to the rear panel 14R via the second bracket B2. The third camera C3 and the third illumination device L3 are attached to the front panel 14F via the third bracket B3. The fourth camera C4 and the fourth illumination device L4 are attached to the rear panel 14R via the fourth bracket B4. The fifth camera C5 and the fifth illumination device L5 are attached to the front panel 14F via the fifth bracket B5. The sixth camera C6 and the sixth illumination device L6 are attached to the rear panel 14R via the sixth bracket B6. The seventh camera C7 and the seventh illumination device L7 are attached to the front panel 14F via the seventh bracket B7. The eighth camera C8 and the eighth illumination device L8 are attached to the rear panel 14R via the eighth bracket B8. The ninth camera C9 and the ninth illumination device L9 are attached to the front panel 14F via the ninth bracket B9. That is, the odd-numbered cameras C1, C3, C5, C7, and C9 and the odd-numbered illumination devices L1, L3, L5, L7, and L9 are attached to the front panel 14F, and the even-numbered cameras C2, C4, C6, C8, and the even-numbered illumination devices L2, L4, L6, L8 are attached to the rear panel 14R.

Sets of the cameras C1 to C9 and the illumination devices L1 to L9, which are attached to the brackets B1 to B9, individually constitute imaging units U1 to U9, respectively. Hereinafter, as necessary, a set of the first camera C1 and the first illumination device L1 will be referred to as a “first imaging unit U1”, a set of the second camera C2 and the second illumination device L2 will be referred to as a “second imaging unit U2”, a set of the third camera C3 and the third illumination device L3 will be referred to as a “third imaging unit U3”, a set of the fourth camera C4 and the fourth illumination device L4 will be referred to as a “fourth imaging unit U4”, a set of the fifth camera C5 and the fifth illumination device L5 will be referred to as a “fifth imaging unit U5”, a set of the sixth camera C6 and the sixth illumination device L6 will be referred to as a “sixth imaging unit U6”, a set of the seventh camera C7 and the seventh illumination device L7 will be referred to as a “seventh imaging unit U7”, a set of the eighth camera C8 and the eighth illumination device L8 will be referred to as an “eighth imaging unit U8”, and a set of the ninth camera C9 and the ninth illumination device L9 will be referred to as a “ninth imaging unit U9” to distinguish the respective imaging units U1 to U9.

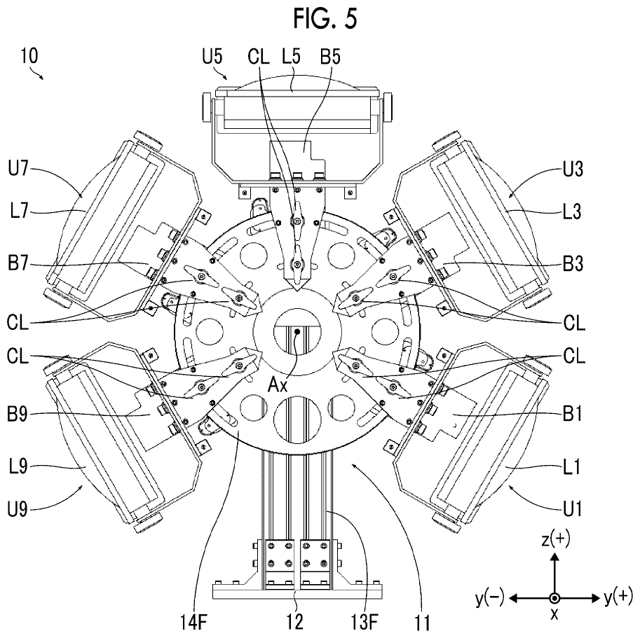

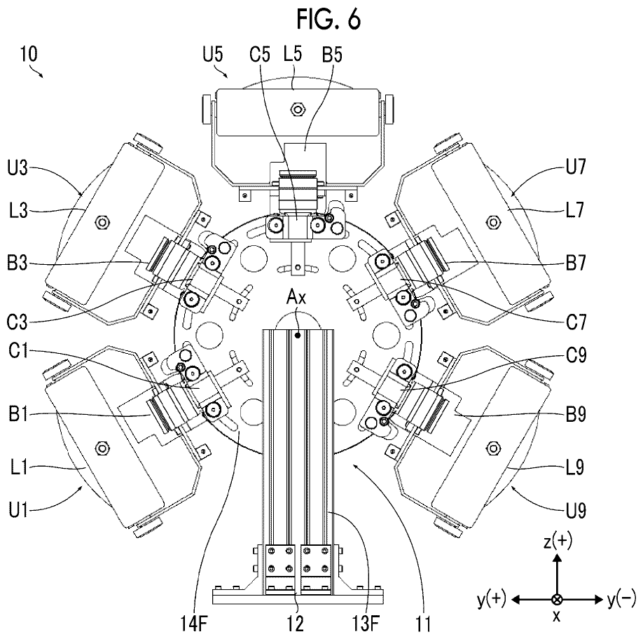

FIG. 5 is a front view showing an attachment state of the cameras and the illumination devices to the front panel. In addition, FIG. 6 is a rear view showing the attachment state of the cameras and the illumination devices to the front panel.

Each of the brackets B1, B3, B5, B7, and B9 is disposed on the same circumference with respect to the front panel 14F. In addition, each of the brackets B1, B3, B5, B7, and B9 is attached to the front panel 14F to be movable in a circumferential direction within a predetermined angular range (for example,) 30°. Each of the brackets B1, B3, B5, B7, and B9 is fixed to the front panel 14F by a clamp (for example, a toggle clamp) CL. Therefore, position adjustment can be easily performed by loosening the clamp CL.

The cameras C1, C3, C5, C7, and C9 are mounted on camera mounting portions comprised in the brackets B1, B3, B5, B7, and B9. In addition, the illumination devices L1, L3, L5, L7, and L9 are mounted on illumination mounting portions comprised in the brackets B1, B3, B5, B7, and B9. The cameras C1, C3, C5, C7, and C9 are attached to the camera mounting portions using, for example, screw holes for a tripod. The illumination devices L1, L3, L5, L7, and L9 are attached to the illumination mounting portions by fixing an arm portion with a bolt.

The cameras C1, C3, C5, C7, and C9 and the illumination devices L1, L3, L5, L7, and L9 attached to the front panel 14F via the brackets B1, B3, B5, B7, and B9 are disposed at the frame 11 in a predetermined posture. Specifically, the cameras C1, C3, C5, C7, and C9 and the illumination devices L1, L3, L5, L7, and L9 are disposed radially outward (normal direction) about the axis Ax of the multi-eye imaging apparatus 10 in a plane (in a zy-plane) orthogonal to the axis Ax of the multi-eye imaging apparatus 10. More specifically, the cameras C1, C3, C5, C7, and C9 are disposed such that imaging optical axes thereof are directed radially outward (normal direction) about the axis Ax of the multi-eye imaging apparatus 10. In addition, bottom surfaces of camera bodies of the cameras C1, C3, C5, C7, and C9 are attached in parallel with the front panel 14F (in parallel with the zy-plane) (a bottom side of an image sensor is attached in parallel with the zy-plane). Accordingly, each of the cameras C1, C3, C5, C7, and C9 is disposed at a predetermined interval in the circumferential direction in the zy-plane about the axis Ax of the multi-eye imaging apparatus 10. The illumination devices L1, L3, L5, L7, and L9 are disposed such that irradiation directions thereof are directed radially outward (normal direction) about the axis Ax of the multi-eye imaging apparatus 10. As a result, the cameras C1, C3, C5, C7, and C9 and the illumination devices L1, L3, L5, L7, and L9 are radially disposed in the zy-plane about the axis Ax of the multi-eye imaging apparatus 10.

Herein, as described above, the brackets B1, B3, B5, B7, and B9 are attached to the front panel 14F to be movable in the circumferential direction within a predetermined angular range. FIGS. 5 and 6 show a state where each of the brackets B1, B3, B5, B7, and B9 is fixed at a reference position. By fixing each of the brackets B1, B3, B5, B7, and B9 at the reference position, the first camera C1 and the first illumination device L1 are disposed at positions of) 330° (−30°) in front view (FIG. 5). In addition, the third camera C3 and the third illumination device L3 are disposed at positions of 30°. In addition, the fifth camera C5 and the fifth illumination device L5 are disposed at positions of 90°. In addition, the seventh camera C7 and the seventh illumination device L7 are disposed at positions of 150°. In addition, the ninth camera C9 and the ninth illumination device L9 are disposed at positions of 210°.

Each of the brackets B1, B3, B5, B7, and B9 is attached to be movable in a range of ±15° in the circumferential direction from the reference position. Therefore, a position of each of the cameras C1, C3, C5, C7, and C9 and the illumination devices L1, L3, L5, L7, and L9 can be adjusted in a range of ±15° in the circumferential direction from the reference position.

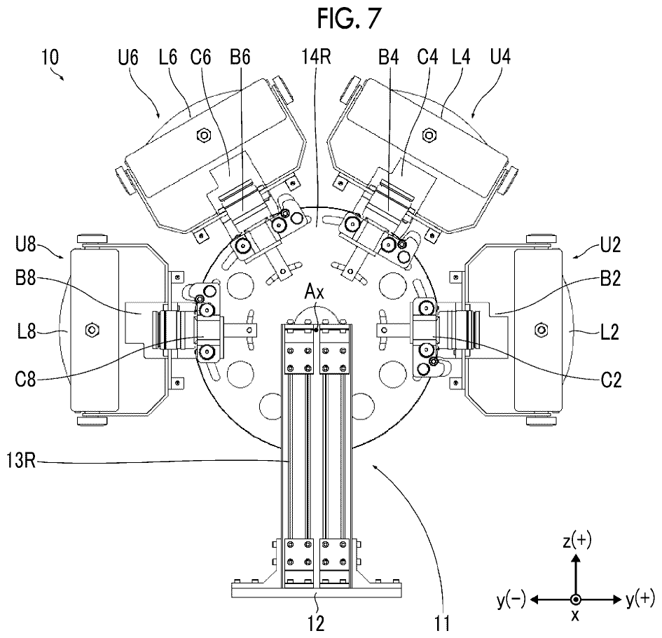

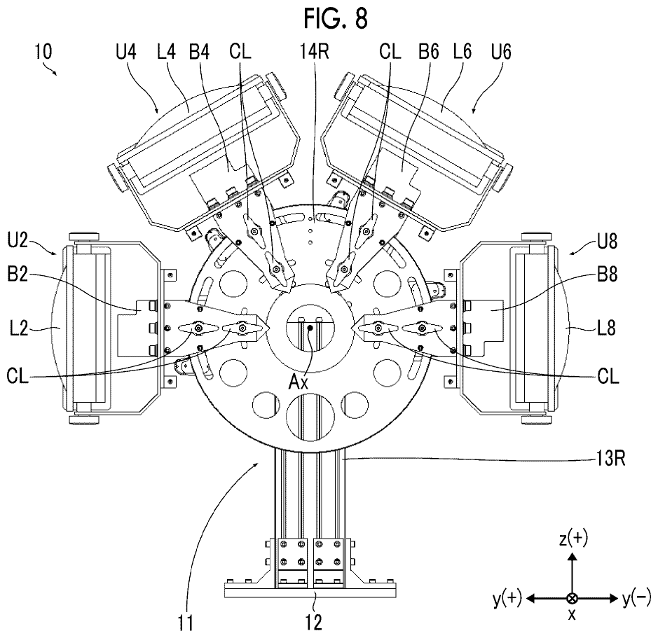

FIG. 7 is a front view showing an attachment state of the cameras and the illumination devices to the rear panel. In addition, FIG. 8 is a rear view showing the attachment state of the cameras and the illumination devices to the rear panel.

Each of the brackets B2, B4, B6, and B8 is disposed on the same circumference with respect to the rear panel 14R. In addition, each of the brackets B2, B4, B6, and B8 is attached to the rear panel 14R to be movable in the circumferential direction within a predetermined angular range (for example,) 30°. In addition, each of the brackets B2, B4, B6, and B8 is fixed to the rear panel 14R by the clamp CL. Therefore, position adjustment can be easily performed by loosening the clamp CL.

The cameras C2, C4, C6, and C8 are mounted on camera mounting portions comprised in the brackets B2, B4, B6, and B8. In addition, the illumination devices L2, L4, L6, and L8 are mounted on illumination mounting portions comprised in the brackets B2, B4, B6, and B8. The cameras C2, C4, C6, and C8 are attached to the camera mounting portions using, for example, screw holes for a tripod. The illumination devices L2, L4, L6, and L8 are attached to the illumination mounting portions by fixing an arm portion with a bolt.

The cameras C2, C4, C6, and C8 and the illumination devices L2, L4, L6, and L8 attached to the rear panel 14R via the brackets B2, B4, B6, and B8 are disposed at the frame 11 in a predetermined posture. Specifically, the cameras C2, C4, C6, and C8 and the illumination devices L2, L4, L6, and L8 are disposed radially outward (normal direction) about the axis Ax of the multi-eye imaging apparatus 10 in the plane (in the zy-plane) orthogonal to the axis Ax of the multi-eye imaging apparatus 10. More specifically, the cameras C2, C4, C6, and C8 are disposed such that imaging optical axes thereof are directed radially outward (normal direction) about the axis Ax of the multi-eye imaging apparatus 10. In addition, bottom surfaces of camera bodies of the cameras C2, C4, C6, and C8 are attached in parallel with the rear panel 14R (in parallel with the zy-plane) (a bottom side of an image sensor is attached in parallel with the zy-plane). Accordingly, each of the cameras C2, C4, C6, and C8 is disposed at a predetermined interval in the circumferential direction in the zy-plane about the axis Ax of the multi-eye imaging apparatus 10. The illumination devices L2, L4, L6, and L8 are disposed such that irradiation directions thereof are directed radially outward (normal direction) about the axis Ax of the multi-eye imaging apparatus 10. As a result, the cameras C2, C4, C6, and C8 and the illumination devices L2, L4, L6, and L8 are radially disposed in the zy-plane about the axis Ax of the multi-eye imaging apparatus 10.

Herein, as described above, the brackets B2, B4, B6, and B8 are attached to the rear panel 14R to be movable in the circumferential direction within a predetermined angular range. FIGS. 7 and 8 show a state where each of the brackets B2, B4, B6, and B8 is fixed at a reference position. By fixing each of the brackets B2, B4, B6, and B8 at the reference position, the second camera C2 and the second illumination device L2 are disposed at positions of 0° in front view (FIG. 7). In addition, the fourth camera C4 and the fourth illumination device L4 are disposed at positions of 60°. In addition, the sixth camera C6 and the sixth illumination device L6 are disposed at positions of 120°. In addition, the eighth camera C8 and the eighth illumination device L8 are disposed at positions of 180°. Therefore, the second camera C2 is disposed between the first camera C1 and the third camera C3 in the circumferential direction. In addition, the fourth camera C4 is disposed between the third camera C3 and the fifth camera C5 in the circumferential direction. In addition, the sixth camera C6 is disposed between the fifth camera C5 and the seventh camera C7 in the circumferential direction. In addition, the eighth camera C8 is disposed between the seventh camera C7 and the ninth camera C9 in the circumferential direction. Similarly, the second illumination device L2 is disposed between the first illumination device L1 and the third illumination device L3 in the circumferential direction. In addition, the fourth illumination device L4 is disposed between the third illumination device L3 and the fifth illumination device L5 in the circumferential direction. In addition, the sixth illumination device L6 is disposed between the fifth illumination device L5 and the seventh illumination device L7 in the circumferential direction. In addition, the eighth illumination device L8 is disposed between the seventh illumination device L7 and the ninth illumination device L9 in the circumferential direction.

Each of the brackets B2, B4, B6, and B8 is attached to be movable in a range of ±15° in the circumferential direction from the reference position. Therefore, a position of each of the cameras C2, C4, C6, and C8 and the illumination devices L2, L4, L6, and L8 can be adjusted in a range of ±15° in the circumferential direction from the reference position.

In the multi-eye imaging apparatus 10 configured as described above, the nine cameras C1 to C9 and the nine illumination devices L1 to L9 are disposed at predetermined intervals on a circumference about on the axis Ax of the apparatus. In a case where the brackets B1 to B9 are fixed at the reference positions, each of the cameras C1 to C9 and the illumination devices L1 to L9 is disposed at an interval of 30°. In addition, each of the cameras C1 to C9 and the illumination devices L1 to L9 is attached to be positionally adjustable in the circumferential direction in a range of ±15°. Each of the cameras C1 to C9 is positionally adjusted such that imaging ranges overlap between cameras adjacent to each other. More specifically, the cameras C1 to C9 are positionally adjusted such that the imaging ranges overlap each other at a predetermined overlap ratio (also referred to as a side lap ratio). For example, the cameras C1 to C9 are positionally adjusted such that the imaging ranges overlap each other with an overlap ratio of 20% or more.

The cameras C1 to C9 to be used are digital cameras. The type of digital camera is not particularly limited. It is sufficient that the digital camera has a function of electrically recording images (still images and/or motion pictures). For example, a lens-interchangeable digital camera is used. In the present embodiment, the cameras C1 to C9 have a storage (storage medium) and store captured images in the storage. The storage may be a built-in memory or an interchangeable memory (so-called memory card).

The illumination devices L1 to L9 to be used are not particularly limited. For example, a halogen lamp is used. In addition, for example, a light emitting diode (LED) lamp, a xenon lamp, or the like can be used. In the present embodiment, an illumination device having a function of adjusting an irradiation angle (irradiation direction) is used. Each of the illumination devices L1 to L9 is rotated (swivels in the front-rear direction) about an axis orthogonal to the optical axes of the cameras C1 to C9, and the irradiation angle is adjusted. The illumination devices L1 to L9 have irradiation ranges that can cover the imaging ranges of the cameras C1 to C9.

### Relay Device

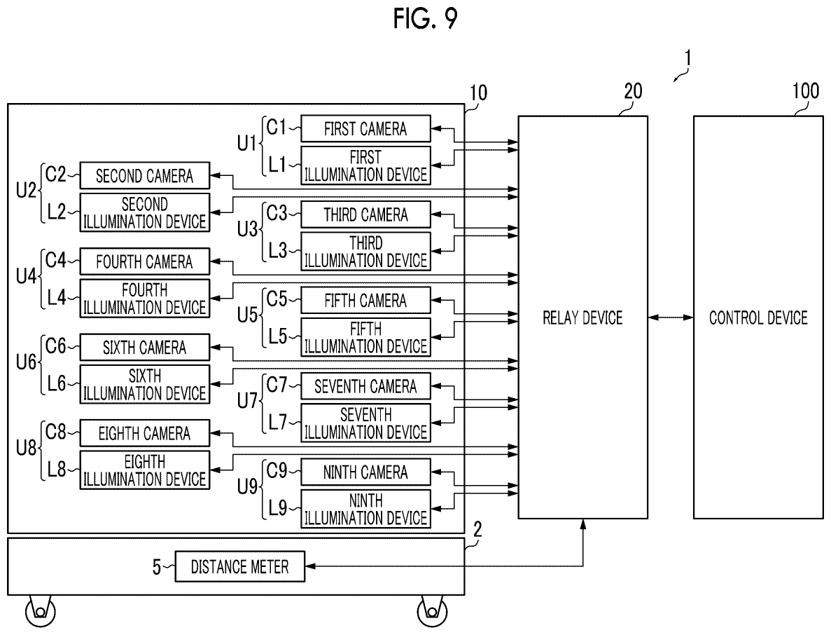

FIG. 9 is a block diagram showing a system configuration of the imaging system.

As shown in FIG. 9, the multi-eye imaging apparatus 10 and the distance meter 5 are connected to the control device 100 via the relay device 20 in a communicable manner. The relay device 20 is composed of, for example, a computer having a communication function. The relay device 20 is mounted on the cart 2 together with the multi-eye imaging apparatus 10.

The cameras C1 to C9 and the illumination devices L1 to L9 comprised in the multi-eye imaging apparatus 10 are connected to the relay device 20. A connection form between each of the cameras C1 to C9 and the relay device 20 and a connection form between each of the illumination devices L1 to L9 and the relay device 20 are not particularly limited. The connection may be wired connection or wireless connection. For example, in the present embodiment, each of the cameras C1 to C9 and each of the illumination devices L1 to L9 are connected to the relay device 20 in a wired manner.

A connection form between the distance meter 5 and the relay device 20 is also not particularly limited. The connection may be wired connection or wireless connection. For example, in the present embodiment, the distance meter 5 is wirelessly connected to the relay device 20. For example, the distance meter 5 is connected to the relay device 20 through short-range wireless communication such as Bluetooth (registered trademark).

A connection form between the control device 100 and the relay device 20 is also not particularly limited. The connection may be wired connection or wireless connection. For example, in the present embodiment, the control device 100 and the relay device 20 are wirelessly connected. For example, the control device 100 and the relay device 20 are connected through a wireless local area network (LAN) such as Wi-Fi (registered trademark).

### Control Device

The control device 100 is composed of a computer having a communication function. For example, in the present embodiment, the control device 100 is composed of a tablet computer.

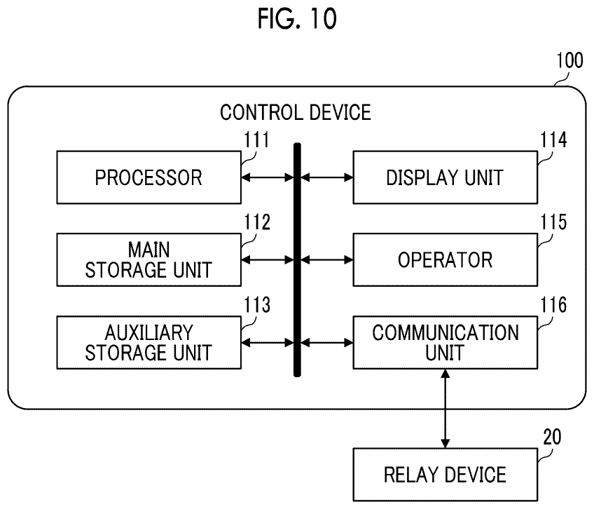

FIG. 10 is a diagram showing an example of a hardware configuration of the control device.

The control device 100 comprises a processor 111, a main storage unit 112, an auxiliary storage unit 113, a display unit 114, an operator 115, a communication unit 116, and the like.

The processor 111 executes a program to function as various types of processing sections. For example, in the present embodiment, the processor 111 is composed of a central processing unit (CPU). The program (an image processing program or the like) executed by the processor 111, various types of data required for control, calculation, and the like, and the like are stored in the main storage unit 112 and/or the auxiliary storage unit 113.

The main storage unit 112 includes a random access memory (RAM) and a read only memory (ROM). The RAM is used as a work area of the processor 111. The ROM stores a basic input/output program and the like.

The auxiliary storage unit 113 is composed of, for example, an electrically erasable and programmable ROM (EEPROM), a solid state drive (SSD), or the like.

The display unit 114 is composed of, for example, a liquid crystal display, an organic electro luminescence diode display, or the like.

The operator 115 includes a touch panel, various operation buttons, and the like. The touch panel detects a touch operation on a screen of the display unit 114.

The communication unit 116 connects the control device 100 and an external device (the relay device 20 or the like) in a communicable manner. As described above, in the present embodiment, the control device 100 and the relay device 20 are connected through a wireless LAN (for example, Wi-Fi). Accordingly, the communication unit 116 has at least a communication function using a wireless LAN.

### Functions of Control Device

The control device 100 has a function of controlling imaging (imaging control function) and a function of presenting an imaging status of each of the cameras C1 to C9 to a user (monitor function), and the like, with respect to imaging performed by the multi-eye imaging apparatus 10.

### Imaging Control Function

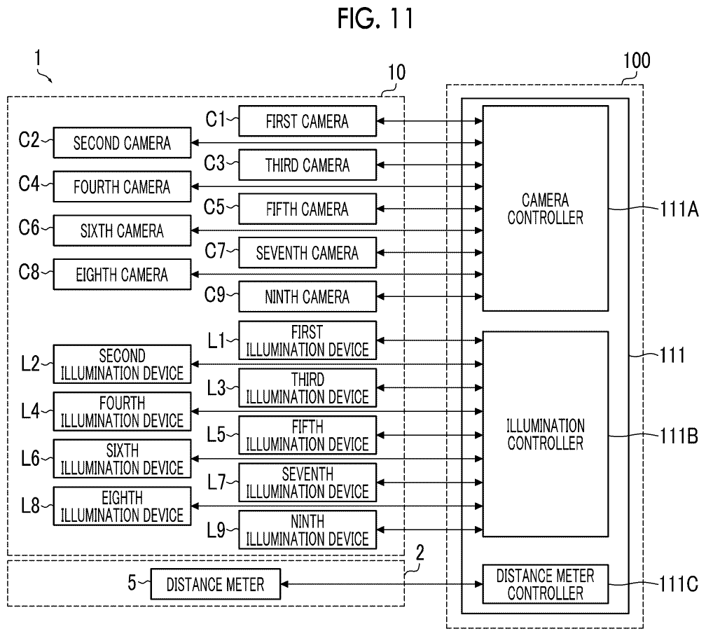

FIG. 11 is a block diagram of main functions related to imaging control.

As shown in FIG. 11, the control device 100 has functions of a camera controller 111A, an illumination controller 111B, a distance meter controller 111C, and the like, as functions related to imaging control. The functions of the respective units are realized by the processor 111 executing a predetermined program.

The camera controller 111A controls an operation of each of the cameras C1 to C9 mounted on the multi-eye imaging apparatus 10. The camera controller 111A controls each of the cameras C1 to C9 based on an operation input from the operator 115 and causes each of the cameras C1 to C9 to execute predetermined imaging. That is, imaging of a still image or a motion picture is executed. The imaging of a still image includes so-called interval imaging. The interval imaging is a function of repeatedly performing the imaging of a still image at a regular time interval.

In a case of capturing a still image, the camera controller 111A causes each of the cameras C1 to C9 to capture a still image in response to an imaging instruction from the operator 115.

In a case of performing interval imaging, the camera controller 111A causes each of the cameras C1 to C9 to start interval imaging in response to an imaging start instruction from the operator 115. That is, imaging of a still image is performed at a regular time interval. In addition, the camera controller 111A causes each of the cameras C1 to C9 to end the imaging in response to an imaging end instruction from the operator 115.

In a case of capturing a motion picture, the camera controller 111A causes each of the cameras C1 to C9 to start capturing of a motion picture in response to an imaging start instruction from the operator 115. In addition, the camera controller 111A causes each of the cameras C1 to C9 to end the capturing of a motion picture in response to an imaging end instruction from the operator 115.

The illumination controller 111B controls an operation of each of the illumination devices L1 to L9 mounted on the multi-eye imaging apparatus 10. The illumination controller 111B controls each of the illumination devices L1 to L9 based on an operation input from the operator 115 to control emission of illumination light. The control of the emission includes not only control of turning on and off of illumination light but also control of brightness.

The distance meter controller 111C controls an operation of the distance meter 5 mounted on the cart 2. The distance meter controller 111C controls the distance meter 5 based on an operation input from the operator 115. For example, processing of resetting of measurement or the like is performed.

### Monitor Function

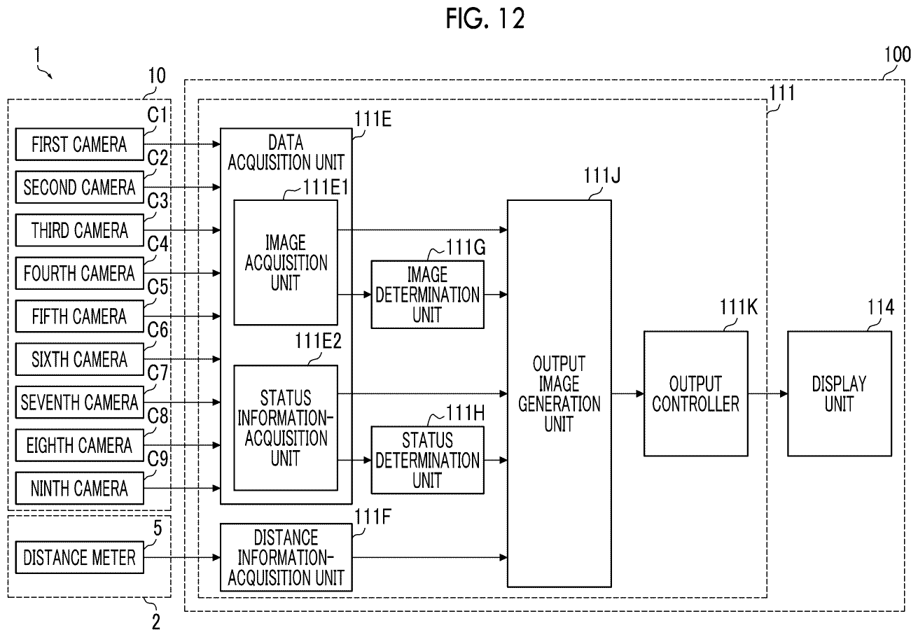

FIG. 12 is a block diagram of main functions related to presentation of an imaging status.

As shown in FIG. 12, the control device 100 has functions of a data acquisition unit 111E, a distance information-acquisition unit 111F, an image determination unit 111G, a status determination unit 111H, an output image generation unit 111J, an output controller 111K, and the like, as functions related to presentation of an imaging status. The functions of the respective units are realized by the processor 111 executing a predetermined program. In the present embodiment, the control device 100 that provides the monitor function is an example of the image processing apparatus. In addition, a program for causing the processor 111 to realize the monitor function is an example of the image processing program.

### (1) Data Acquisition Unit

The data acquisition unit 111E acquires a captured image, status information, and the like from each of the cameras C1 to C9 constituting the multi-eye imaging apparatus 10. The data acquisition unit 111E has functions of an image acquisition unit 111E1, a status information-acquisition unit 111E2, and the like.

The image acquisition unit 111E1 acquires a captured image from each of the cameras C1 to C9. In a case where imaging is performed, each of the cameras C1 to C9 outputs an image (captured image) obtained by imaging to the control device 100. The image acquisition unit 111E1 acquires a captured image output from each of the cameras C1 to C9. The captured images are output from the cameras C1 to C9 in time series order of the imaging (in imaging order). Accordingly, the captured images are acquired in time series order. In a case of a motion picture, an image constituting each frame is output in time series order. Accordingly, even in the case of a motion picture, a captured image (an image constituting the frame) is acquired in time series. The captured image acquired by the image acquisition unit 111E1 is applied to the image determination unit 111G and the output image generation unit 111J. In the present embodiment, the captured image output from each of the cameras C1 to C9 is an example of a first image.

The status information-acquisition unit 111E2 acquires information related to a state of a camera from each of the cameras C1 to C9 (status information). The status information includes information such as information on a remaining battery level, information on a remaining memory level, and information on a communication status. The information on a communication status is information on a communication state (connection state) between each of the cameras C1 to C9 and the control device 100. For example, in the present embodiment, as the status information, information on a remaining battery level and information on a communication status are acquired from each of the cameras C1 to C9. The status information acquired by the status information-acquisition unit 111E2 is applied to the status determination unit 111H and the output image generation unit 111J. In the present embodiment, the status information is an example of fifth information related to a state of the camera.

### (2) Distance Information-Acquisition Unit

The distance information-acquisition unit 111F acquires, from the distance meter 5, information on a distance. As described above, the distance is a distance from the starting point to the current position. The distance meter 5 measures a distance to the current position of the cart 2 with the starting point as 0 and outputs the distance to the control device 100. The information on a distance acquired by the distance information-acquisition unit 111F is applied to the output image generation unit 111J.

### (3) Image Determination Unit

The image determination unit 111G analyzes a captured image of each of the cameras C1 to C9 and determines whether or not the captured image is appropriate as an image for inspection (OK or NG). In the present embodiment, whether or not the captured image is appropriate as an image for inspection is determined from viewpoints of image quality and an overlap ratio.

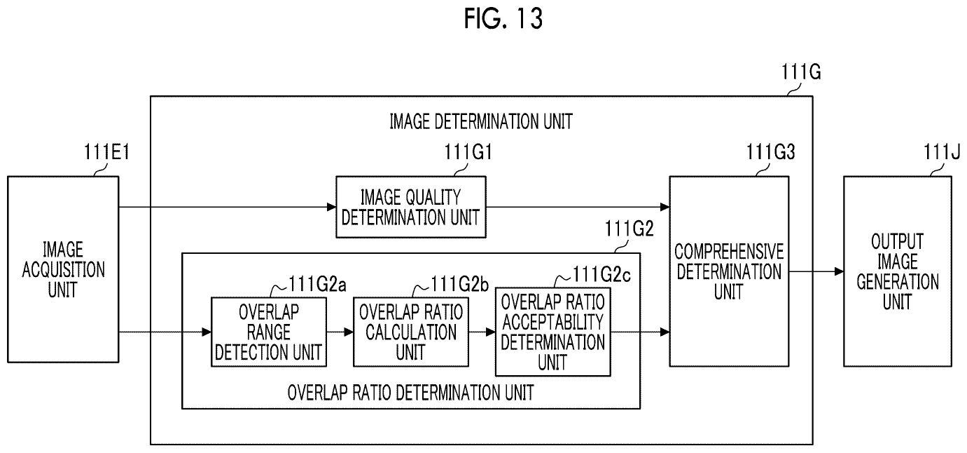

FIG. 13 is a block diagram of main functions of the image determination unit.

As shown in FIG. 13, the image determination unit 111G has functions of an image quality determination unit 111G1, an overlap ratio determination unit 111G2, a comprehensive determination unit 111G3, and the like.

### (3-1) Image Quality Determination Unit

The image quality determination unit 111G1 determines whether or not a captured image is appropriate as an image for inspection from a viewpoint of image quality. The image quality determination unit 111G1 analyzes the captured image and determines whether or not required image quality is satisfied. That is, whether or not the image quality (for example, image quality in which fissuring having a width of 0.2 mm can be detected) satisfies the purpose of inspection is determined. The image quality determination unit 111G1 checks image quality, for example, in viewpoints of brightness, blurriness, image blur, fog, and the like and determines whether or not the image quality satisfies the purpose of inspection. A known technique can be adopted for checking the image quality. For example, a configuration where the image quality is checked by using a trained model that has been subjected to machine learning to check an image for the purpose of inspection can be adopted.

In a case where requirements of image quality are satisfied, the image quality determination unit 111G1 outputs the result as an OK image to the comprehensive determination unit 111G3. In a case where the requirements for image quality are not satisfied, the image quality determination unit 111G1 outputs the result as an NG image (an image with an imaging failure) to the comprehensive determination unit 111G3.

### (3-2) Overlap Ratio Determination Unit

The overlap ratio determination unit 111G2 determines whether or not a captured image is appropriate as an image for inspection from the viewpoint of an overlap ratio. The captured image is panoramically composed and is used later. In a case where an overlap ratio of captured images between cameras adjacent to each other is insufficient, a problem occurs in the composition. For this reason, acceptability of a captured image is determined from the viewpoint of an overlap ratio.

As shown in FIG. 13, the overlap ratio determination unit 111G2 has functions of an overlap range detection unit 111G2a, an overlap ratio calculation unit 111G2b, an overlap ratio acceptability determination unit 111G2c, and the like.

The overlap range detection unit 111G2a processes an image acquired from each of the cameras C1 to C9 to detect a range in which captured images overlap each other between cameras adjacent to each other. Specifically, a range in which the captured images overlap each other is detected between the first camera C1 and the second camera C2, between the second camera C2 and the third camera C3, between the third camera C3 and the fourth camera C4, between the fourth camera C4 and the fifth camera C5, between the fifth camera C5 and the sixth camera C6, between the sixth camera C6 and the seventh camera C7, between the seventh camera C7 and the eighth camera C8, and between the eighth camera C8 and the ninth camera C9.

A known method is adopted for detecting an overlap range through image processing. For example, the overlap range detection unit 111G2a detects a feature point of an object in each of two images and detects an overlap range of the two images based on the detected feature point. The detection result is output to the overlap ratio calculation unit 111G2b.

The overlap ratio calculation unit 111G2b calculates an overlap ratio (also referred to as a side lap ratio) of captured images between cameras adjacent to each other. The overlap ratio is calculated as a proportion of an overlap of images of cameras adjacent to each other with respect to the entire image. Therefore, for example, in a case where an area of the entire image is defined as Sa and an area of a region where images of cameras adjacent to each other overlap each other in the entire image is defined as Sb, an overlap ratio R is calculated through R=Sb/Sa.

An overlap ratio between an image of the first camera C1 and an image of the second camera C2 is calculated as an overlap ratio of an image. In addition, an overlap ratio between the image of the second camera C2 and an image of the third camera C3 is calculated. That is, an overlap ratio between an image of the nth camera and an image of the (n+1)th camera is calculated (n=1, 2, . . . , 8).

The overlap ratio calculation unit 111G2b calculates an overlap ratio between respective images based on a detection result of the overlap range detection unit 111G2a. The calculation result is output to the overlap ratio acceptability determination unit 111G2c.

The overlap ratio acceptability determination unit 111G2c determines acceptability (OK or NG) of a captured image of each of the cameras C1 to C9 based on an overlap ratio calculated by the overlap ratio calculation unit 111G2b. As described above, the image captured by each of the cameras C1 to C9 is panoramically composed and is used later. In order to panoramically compose the image captured by each of the cameras C1 to C9 reliably, it is necessary to have a certain overlap ratio between images adjacent to each other or higher. In addition, even in a case where the panoramic composition is not performed, it is necessary to image the entire circumference without omission. The overlap ratio acceptability determination unit 111G2c acquires the overlap ratio calculated by the overlap ratio calculation unit 111G2b and determines acceptability of the captured image of each of the cameras C1 to C9 by comparing the overlap ratio with a threshold value (for example, 20%). That is, in a case where the overlap ratio is equal to or higher than the threshold value, it is determined that imaging can be performed in a panoramically composable manner or without omission, and it is determined that the imaging is OK. On the other hand, in a case where the overlap ratio is less than the threshold value, it is determined that the panoramic composition is difficult or there is omission in the imaging, and it is determined that the imaging is NG (imaging failure). For example, in a case where an overlap ratio between an image of the nth camera and an image of the (n+1)th camera is less than the threshold value, it is determined that the captured images of the nth camera and the (n+1)th camera are NG.

### (3-3) Comprehensive Determination Unit

The comprehensive determination unit 111G3 comprehensively determines acceptability (OK or NG) of a captured image of each of the cameras C1 to C9 based on a determination result of the image quality determination unit 111G1 and a determination result of the overlap ratio determination unit 111G2. That is, from the viewpoints of image quality and an overlap ratio, it is comprehensively determined whether or not the captured image is appropriate as an image for inspection.

In a case where the determination results of both the image quality determination unit 111G1 and the overlap ratio determination unit 111G2 are determined to be “OK”, the comprehensive determination unit 111G3 determines that the imaging is “OK”. Therefore, in a case where the determination result is “NG” in any one of the determination units, it is determined that the imaging is “NG (imaging failure)”.

A determination result of the comprehensive determination unit 111G3 is applied to the output image generation unit 111J as a determination result of the image determination unit 111G. In the present embodiment, information on the determination result of the image determination unit 111G is an example of first information related to an imaging state of a captured image which is a first image.

### (4) Status Determination Unit

The status determination unit 111H determines the state (status) of each of the cameras C1 to C9 based on status information of each of the cameras C1 to C9 acquired by the status information-acquisition unit 111E2. As described above, in the present embodiment, information on a remaining battery level and information on a communication status are acquired from each of the cameras C1 to C9 as status information. The status determination unit 111H determines a remaining battery level state and a communication status of each of the cameras C1 to C9. For the remaining battery level state, for example, whether or not a remaining battery level is equal to or higher than a threshold value is determined. For the communication status, whether or not it is a communicable state is determined. The determination result of the status determination unit 111H (the determination result of the status) is applied to the output image generation unit 111J.

### (5) Output Image Generation Unit

The output image generation unit 111J generates an image to be output to the display unit 114 (output image). The output image generation unit 111J generates an output image based on a captured image of each of the cameras C1 to C9 acquired by the image acquisition unit 111E1, a determination result of each captured image from the image determination unit 111G, status information of each of the cameras C1 to C9 acquired by the status information-acquisition unit 111E2, information on a determination result of a status from the status determination unit 111H, and distance information acquired by the distance information-acquisition unit 111F. In the present embodiment, the output image is an example of a second image.

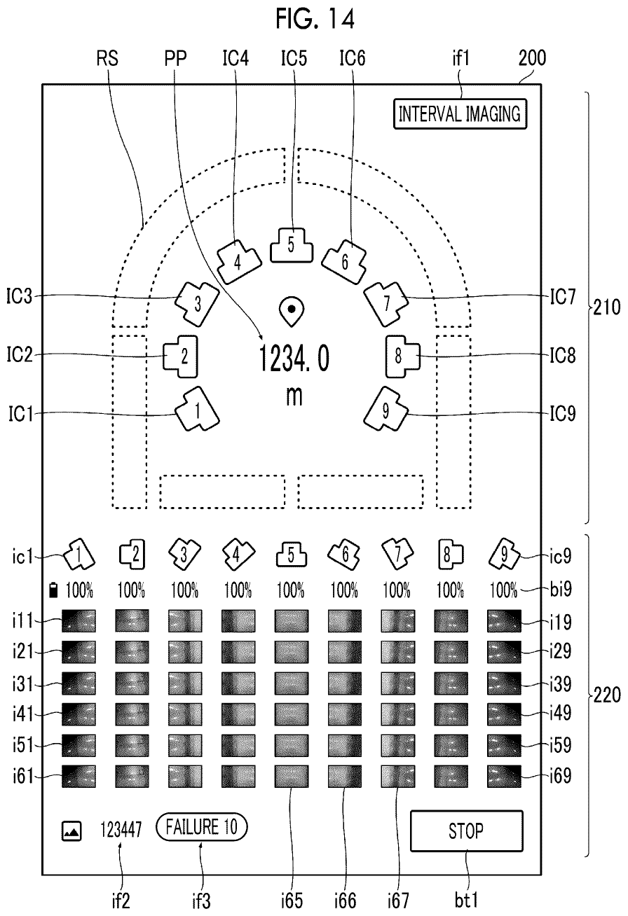

FIG. 14 is a view showing an example of an output image. FIG. 14 shows an example of a case where the screen, which is a display destination, is vertically long.

As shown in FIG. 14, in a case of being output to a display destination, an output image 200 is composed of an operating status display region 210 in which an operating status of the multi-eye imaging apparatus 10 is displayed and a captured image display region 220 in which an image captured by the multi-eye imaging apparatus 10 (captured image) is displayed. As shown in FIG. 14, in a case where the screen, which is a display destination, is vertically long, the operating status display region 210 and the captured image display region 220 are disposed vertically.

### (5-1) Operating Status Display Region

An operating status of the multi-eye imaging apparatus 10 is displayed in the operating status display region 210. More specifically, the operating status of each of the cameras C1 to C9 of the multi-eye imaging apparatus 10 is displayed.

As shown in FIG. 14, in the present embodiment, a configuration where icons (hereinafter, referred to as “camera icons”) IC1 to IC9 indicating the respective cameras C1 to C9 are disposed in a predetermined layout, and operating statuses of the respective cameras C1 to C9 are displayed with colors of the camera icons IC1 to IC9 is adopted.

The camera icons IC1 to IC9 are composed of a combination of a figure resembling a camera and a number. The number displayed in the figure resembling a camera corresponds to the number of each of the cameras C1 to C9. For example, the camera icon IC1 with number 1 corresponds to the first camera C1, and the camera icon IC2 with number 2 corresponds to the second camera C2.

Each of the camera icons IC1 to IC9 is disposed in the operating status display region 210 in disposition corresponding to disposition of each of the cameras C1 to C9 in the multi-eye imaging apparatus 10 (disposition in rear view). Therefore, the camera icons IC1 to IC9 are disposed on the same circumference at regular angular intervals. In the present embodiment, the camera icon IC5 of the fifth camera C5 is disposed at a position of 90 degrees, and the camera icons IC1 to IC9 of the respective cameras C1 to C9 are disposed on the same circumference at intervals of 30 degrees. In addition, the camera icons IC1 to IC9 of the cameras C1 to C9 are disposed in directions corresponding to the directions of the corresponding cameras, respectively. For example, the camera icon IC5 of the fifth camera C5 is disposed directly facing above in accordance with the direction of the fifth camera C5.

In the present embodiment, the camera icons IC1 to IC9 of the respective cameras C1 to C9 are examples of a first symbol or a first figure indicating each camera. In addition, information on a figure configured by disposing the camera icons IC1 to IC9 of the cameras C1 to C9 in an arc shape is an example of fourth information related to a dispositional relationship between the plurality of cameras.

A figure (hereinafter, referred to as an “imaging target outline figure”) RS showing an outline of an imaging target is further displayed in the operating status display region 210. In a case where the imaging target is a tunnel, the imaging target outline figure RS is composed of a figure showing an outline of a cross section of the tunnel. FIG. 14 shows an example of a case where the imaging target, which is a tunnel, is a horseshoe-shaped tunnel. In a case where the tunnel, which is an imaging target, is a circular tunnel, a circular figure is displayed, in a case where the tunnel is a semicircular tunnel, a semicircular figure is displayed, and in a case where the tunnel is a square tunnel, a square figure is displayed. It is sufficient for the imaging target outline figure RS to have an approximate shape of the imaging target that can be ascertained.

FIG. 14 shows an example of a case where the imaging target outline figure RS is composed of a line figure consisting of a broken line. A representation form of the imaging target outline figure RS is not limited thereto and can be represented by changing a line type, a color, and the like.

In a case where the imaging target is a tunnel, as shown in FIG. 14, the camera icons IC1 to IC9 are disposed inside the figure of the tunnel shown by the imaging target outline figure RS and are displayed in the operating status display region 210. Accordingly, setting (an imaging direction and the like) of each of the cameras C1 to C9 with respective to the imaging target can be easily ascertained.

As shown in FIG. 14, position information PP is further displayed in the operating status display region 210. The position information PP is information related to a position of the cart 2. In the present embodiment, information on a distance from the starting point measured by the distance meter 5 is displayed as the position information PP. FIG. 14 shows an example of a case where the position information PP is displayed inside the camera icons IC1 to IC9 disposed in an arc shape. By displaying the position information PP, the current imaging position can be easily ascertained. In the present embodiment, the position information PP is an example of third information related to a position of the moving object.

As described above, in the present embodiment, an operating status of each of the cameras C1 to C9 is displayed with the colors of the camera icons IC1 to IC9.

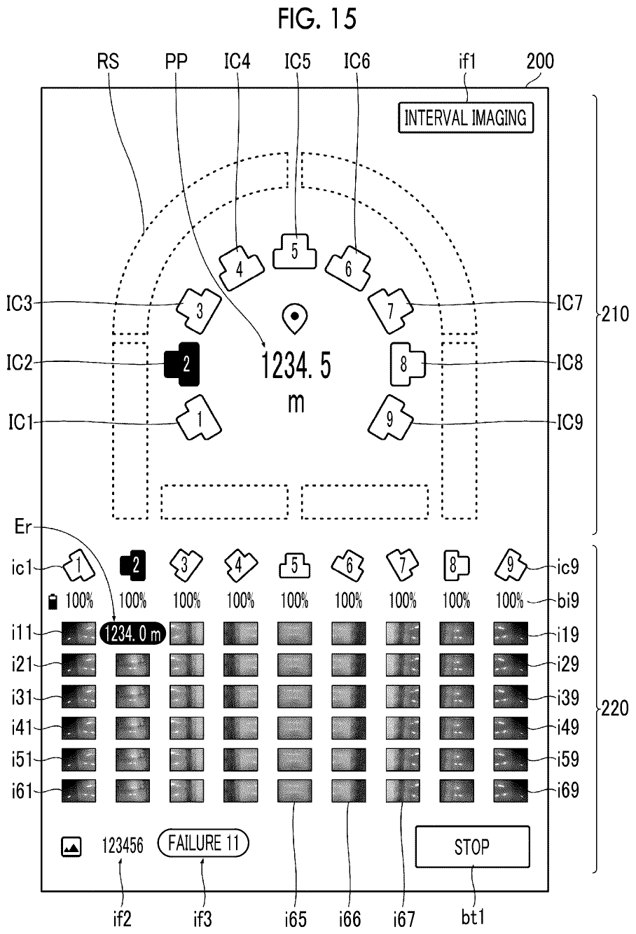

FIG. 15 is a view showing an example of an output image in a case where a problem has occurred in a camera.

As shown in FIG. 15, in a case where a problem occurs in the cameras C1 to C9 constituting the multi-eye imaging apparatus 10, a color of a camera icon of a camera in which the problem has occurred is displayed in an inverted manner. FIG. 15 shows an example in a case where a problem has occurred in the second camera C2. In this case, a color of the camera icon IC2 of the second camera C2 is displayed in an inverted manner. For example, in a case where a color of a camera icon in a normal state (a color of a figure resembling the camera) is white, the color changes to black in a case where a problem occurs.

The problem includes not only a problem of a camera (an insufficient remaining battery level, a communication failure, and the like) based on status information but also a case where an imaging failure has occurred. FIG. 15 shows an example of a case where a captured image of the second camera C2 is determined to be an imaging failure.

As described above, by displaying a color of a camera icon of a camera in which a problem has occurred in an inverted manner, operating statuses of the cameras C1 to C9 can be easily ascertained from images, and the camera in which the problem has occurred can be easily identified. In the present embodiment, inverted color display of the camera icons IC1 to IC9 is an example of highlight display. A method of highlight display is not limited thereto. In addition, for example, a method of changing to another color or turning on and off of display can be adopted.

As shown in FIG. 14, imaging mode information if1 is further displayed in the operating status display region 210. The imaging mode information if1 is information on the currently set imaging mode. In the present embodiment, “still image capturing”, “interval imaging”, or “motion picture imaging” is displayed as the imaging mode information if1. FIG. 14 is an example of a case where the setting of the current imaging mode is “interval imaging”. In the present embodiment, the imaging mode information if1 is disposed at a position of an upper right corner of the operating status display region 210 (a position of an upper right corner of the entire output image).

### (5-2) Captured Image Display Region

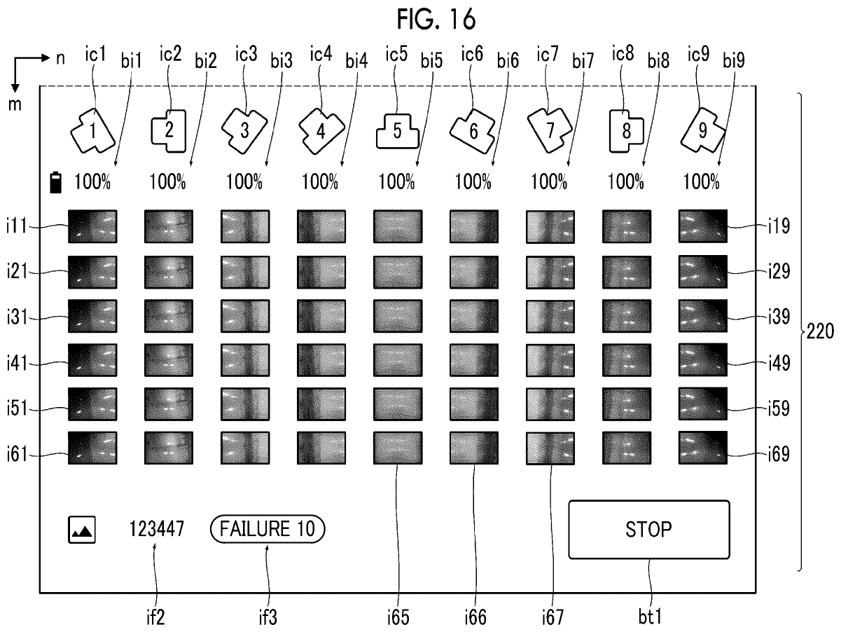

FIG. 16 is an enlarged view of an image display region.

An image captured by the multi-eye imaging apparatus 10 is displayed in the captured image display region 220. That is, a captured image of each of the cameras C1 to C9 is displayed. The captured image is displayed after being reduced to a predetermined size (is displayed as a so-called thumbnail image). In addition, the most recent N captured images are displayed. N is an integer of 2 or more (N≥2). Therefore, a plurality of captured images including the latest captured image are displayed.

As shown in FIG. 16, in the present embodiment, the most recent six captured images imn (m=1, 2, . . . , 6, and n=1, 2, . . . , 9) of the respective cameras C1 to C9 are displayed in a matrix. More specifically, the captured images of the respective cameras C1 to C9 are disposed at regular intervals in a row direction (n direction: a horizontal direction in FIG. 16). In addition, the most recent six captured images of each of the cameras C1 to C9 are disposed at regular intervals in time series order in a column direction (m direction: a vertical direction in FIG. 16).

Arrangement of captured images in the row direction (n direction) is arrangement corresponding to arrangement of the respective cameras C1 to C9 in the multi-eye imaging apparatus 10 (arrangement that is the same as arrangement in a case where arrangement of the respective cameras C1 to C9 in the circumferential direction is developed in a plane). Therefore, the captured images of the respective cameras C1 to C9 are arranged in order of the captured image of the first camera C1, the captured image of the second camera C2, and the like from the left. In the present embodiment, the row direction (n direction) is an example of a first direction.

The arrangement of the captured images in the column direction (m direction) is in imaging order of each of the cameras C1 to C9, and the captured images are disposed in order in which imaging date and time become older from top to bottom. Therefore, a captured image disposed at a highest position is the latest captured image. On the other hand, a captured image disposed at a lowest position is the oldest captured image in display. In the present embodiment, the column direction (m direction) is an example of a second direction.

Camera icons ic1 to ic9 are disposed at head positions of columns of the captured images imn of the respective cameras C1 to C9 displayed in time series order (head positions of columns). The camera icons ic1 to ic9 are composed of the same icon images as those of the camera icons IC1 to IC9 displayed in the operating status display region 210. That is, a figure is composed of a combination of a figure resembling a camera and a number. Hereinafter, as necessary, the camera icons IC1 to IC9 displayed in the operating status display region 210 will be referred to as a “first camera icon”, and the camera icons ic1 to ic9 displayed in the captured image display region 220 will be referred to as a “second camera icon” to distinguish both from each other.

As shown in FIG. 15, in a case where a problem occurs in the corresponding cameras C1 to C9, colors of the second camera icons ic1 to ic9 are also displayed in an inverted manner, similarly to the first camera icons IC1 to IC9.

As described above, by disposing the camera icons ic1 to ic9 at the head positions of the columns of the captured images imn of the respective cameras C1 to C9, a correspondence relationship between each of the cameras C1 to C9 and the captured image imn can be ascertained at a glance. That is, which camera is used to capture an image of each column can be ascertained at a glance.

In addition, in a case where a problem has occurred in the cameras C1 to C9, the occurrence of the problem can be easily ascertained by displaying a color of the corresponding camera icon in an inverted manner. The camera in which the problem has occurred can be easily identified.

In the present embodiment, the second camera icons ic1 to ic9 are examples of a second symbol or a second figure indicating each camera. In addition, in the present embodiment, an aspect in which the second camera icons ic1 to ic9 are disposed at the head positions of the captured images imn of the respective cameras C1 to C9 is an example of an aspect in which both are disposed in association with each other.

As shown in FIG. 16, remaining battery level information pieces bi1 to bi9 of the respective cameras C1 to C9 are further displayed in the captured image display region 220. The remaining battery level information pieces bi1 to bi9 are information on remaining levels of batteries mounted on the respective cameras C1 to C9. In the present embodiment, the remaining battery level information pieces bi1 to bi9 are disposed between the captured images imn of the respective cameras C1 to C9 and the second camera icons ic1 to ic9. That is, the remaining battery level information pieces bi1 to bi9 of the respective cameras C1 to C9 are disposed below the second camera icons ic1 to ic9 of the respective cameras C1 to C9, and subsequently the captured images imn of the respective cameras C1 to C9 are disposed.

FIG. 16 shows an example of a case where the remaining battery level information pieces bi1 to bi9 are displayed in numerical values. The numerical value is displayed in a percentage with a fully charged state as 100. FIG. 16 shows an example of a case where all the cameras C1 to C9 are fully charged (100%).

For a camera of which a remaining battery level is equal to or less than the threshold value, the corresponding remaining battery level information is highlighted and displayed. For example, display is performed in a color different from the normal state. Alternatively, display is performed while being turned on and off.

As described above, by displaying the remaining battery level information pieces bi1 to bi9 in association with the camera icons ic1 to ic9 and the captured images imn of the respective cameras C1 to C9, a state of the remaining battery level of each of the cameras C1 to C9 can be ascertained at a glance. In addition, the user can be prompted to pay attention by highlighting and displaying the remaining battery level information pieces bi1 to bi9 corresponding to a case where the remaining level is insufficient (in a case of being equal to or less than the threshold value).

In the present embodiment, total number-of-captured images information if2, number-of-failure images information if3, an imaging stop button bt1, and the like are further displayed in the captured image display region 220.

The total number-of-captured images information if2 is information on an integrated number of the number of captured images from an imaging start and is a numerical value in the entire apparatus. Therefore, the total number of images captured by the nine cameras C1 to C9 is obtained. In the present embodiment, as shown in FIG. 16, the total number-of-captured images information if2 is disposed at a lower left position of the captured image display region 220 (also a lower left position of the entire output image).

The number-of-failure images information if3 is information on the number of images in which the imaging has failed (images determined to be imaging failures). As shown in FIG. 16, the number-of-failure images information if3 is disposed adjacent to the total number-of-captured images information if2.

The imaging stop button bt1 is a button displayed in a case of interval imaging and capturing a motion picture and is a button for instructing to stop imaging. As the imaging stop button bt1 is touched during the interval imaging and the capturing of a motion picture, the imaging is stopped. In the present embodiment, as shown in FIG. 16, the imaging stop button bt1 is disposed at a lower right position of the captured image display region 220 (also a lower right position of the entire output image).

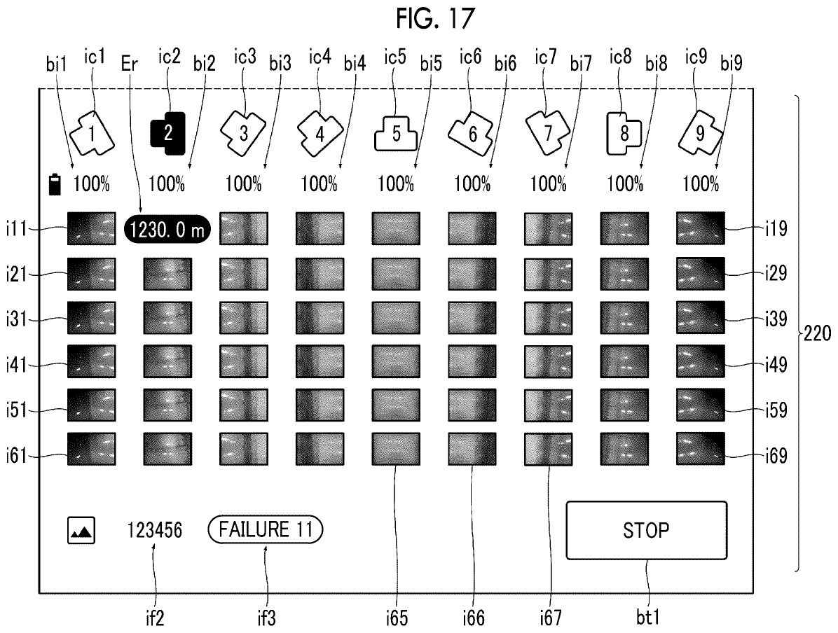

FIG. 17 is a view showing an example of display of the image display region in a case where an imaging failure has occurred.

FIG. 17 shows an example of a case where the latest captured image (an image captured last) is determined to be an imaging failure (comprehensive determination is NG) in the second camera C2.

As shown in FIG. 17, in a case where an imaging failure occurs, an error mark Er is displayed at a display position of a captured image determined to be an imaging failure. In the example shown in FIG. 17, the error mark Er is displayed at a display position of the latest captured image of the second camera C2.

In the present embodiment, the error mark Er is composed of a long hole-shaped figure having a predetermined color, and position information is displayed inside the figure. The position information is information on an imaging position. More specifically, the position information is information on a position of the cart at a point where the captured image determined to be an imaging failure is captured. In the present embodiment, information on a distance from the starting point is displayed.

As described above, by displaying the error mark Er in combination with information on a position where an imaging failure has occurred, the position can be easily identified in a case of reimaging. A color (a background color for displaying the position information) of a figure constituting the error mark Er is preferably a color that attracts attention, such as red. In the present embodiment, the error mark Er is an example of second information indicating the imaging failure.

### (6) Output Controller

The output controller 111K outputs the output image 200 generated by the output image generation unit 111J to the display unit 114 which is a display destination.

### Operation of Imaging System

Hereinafter, a case where the inner wall surface of the tunnel is imaged using the imaging system 1 of the present embodiment will be described.

As described above, imaging is performed while moving in the tunnel. In the present embodiment, the multi-eye imaging apparatus 10 is moved manually by the hand-pushed cart 2. The cart 2 travels on the rail laid in the tunnel and moves in the tunnel.

In the present embodiment, a case where interval imaging is performed while moving in the tunnel to image the inner wall surface of the tunnel will be described as an example.

### (1) Imaging Preparation

First, the multi-eye imaging apparatus 10 is mounted on the cart 2, and the multi-eye imaging apparatus 10 is positioned at an imaging start position (a starting point of imaging).

Next, an imaging angle of view, a disposed position, and the like of each of the cameras C1 to C9 mounted on the multi-eye imaging apparatus 10 are adjusted. That is, the imaging angle of view, the disposed position, and the like of each of the cameras C1 to C9 are adjusted so that imaging can be performed without omission in the circumferential direction. In this case, an overlap ratio between cameras adjacent to each other is set to satisfy a requirement (for example, an overlap ratio of 20% or more).

Next, the control device 100 is connected. That is, the control device 100, the multi-eye imaging apparatus 10, and the distance meter 5 are set in a communicable state. Accordingly, the control device 100 can control the multi-eye imaging apparatus 10 and the distance meter 5. In addition, the control device 100 can acquire information on an image captured by the multi-eye imaging apparatus 10 and a distance measured by the distance meter 5.

At the imaging start position, the distance meter 5 is reset and is set to measure the distance from 0.

### (2) Imaging

After the imaging preparation is completed, imaging is started. As described above, the imaging is performed as interval imaging. In this case, an imaging interval is set to a time interval at which the imaging can be performed without omission in a movement direction. In the present embodiment, a configuration where the cart 2 is manually moved is adopted. Accordingly, the time interval is set to a time interval at which the imaging can be performed without omission in a case where the imaging is performed while a person walks at a walking speed while pushing the cart 2.

Setting of an imaging mode and instructing to start imaging are performed by the control device 100. The user gives an instruction to set the imaging mode and to start interval imaging on the screen of the display unit 114. The control device 100 starts the interval imaging in response to an imaging start instruction from the user. In addition, the user starts moving after the instruction to start imaging. That is, the cart 2 is moved in the tunnel while being pushed.

As described above, in the interval imaging, still images are repeatedly captured at a regular time interval. Accordingly, images are captured in time series. Each of the cameras C1 to C9 mounted on the multi-eye imaging apparatus 10 performs imaging in synchronization with each other.

With the start of imaging, the predetermined output image 200 is displayed on the screen of the display unit 114 (see FIG. 14). As described above, in the output image 200, images (captured images) captured by each of the cameras C1 to C9 are displayed in time series order for each camera. The captured images of each of the cameras C1 to C9 are displayed in the captured image display region 220 in the output image 200.

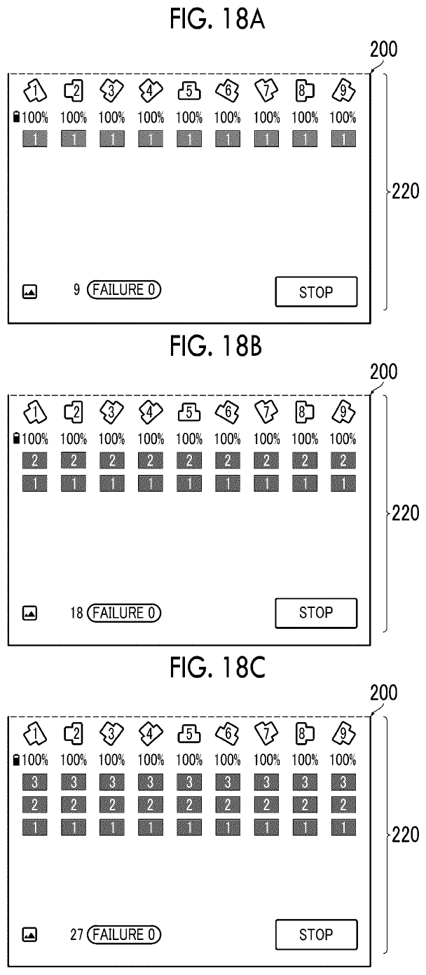

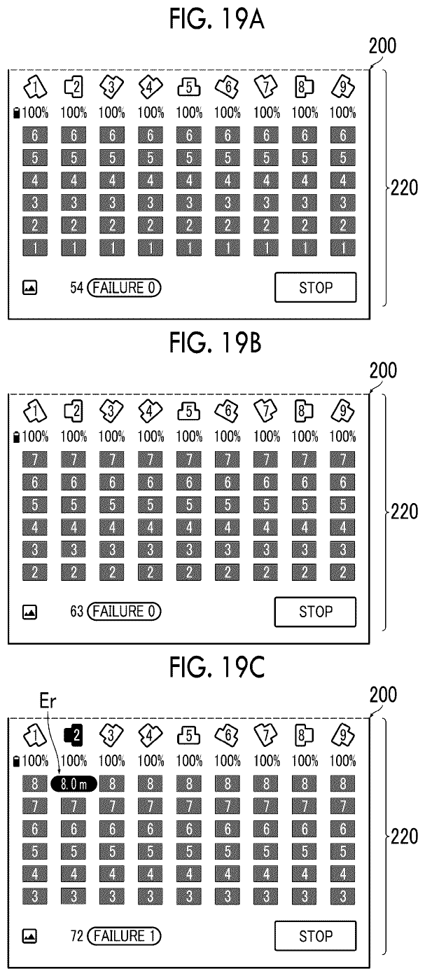

FIGS. 18A to 19C are views showing a state of a change in the captured image display region with progress of imaging. In FIGS. 18A to 19C, a number in a frame indicating the captured image of each of the cameras is a number indicating the order of imaging. For example, the number “1” indicates an image captured first, and the number “2” indicates an image captured second.

FIG. 18A shows display of the captured image display region 220 in a case where the first image is captured. As shown in FIG. 18A, an image (the captured image of the first image) captured by each of the cameras C1 to C9 is displayed in a horizontal line.

FIG. 18B shows display of the captured image display region 220 in a case where a second image is captured. As shown in FIG. 18B, in a case where the second image is captured, the first captured image is displayed at a position one step lower. Then, the second captured image (latest captured image) is displayed at the highest position.

FIG. 18C shows display of the captured image display region 220 in a case where a third image is captured. As shown in FIG. 18C, in a case where the third image is captured, the first captured image and the second captured image are displayed at positions one step lower, respectively. Then, the third captured image (latest captured image) is displayed at the highest position.

FIG. 19A shows display of the captured image display region 220 in a case where a sixth image is captured. In the present embodiment, an upper limit of the number of captured images that can be displayed is six for each camera.

FIG. 19B shows display of the captured image display region 220 in a case where a seventh image is captured. In a case where the number of images exceeds six, the images are deleted in order of the oldest, and the display is updated. Therefore, in a case where the seventh image is captured, the first captured image is deleted.

As described above, images are deleted in the order of the oldest, and display is updated such that the latest captured image is always displayed at the highest position of the column.

FIG. 19C shows display of the captured image display region 220 in a case where an imaging failure has occurred. In particular, FIG. 19C shows an example in a case where the imaging failure has occurred in the captured image of the second camera C2 in a case where an eighth image is captured. In this case, the error mark Er is displayed at a display position of the latest captured image (the highest position of the column) of the second camera C2. As described above, position information of the cart 2 in a case where the image is captured is displayed in the error mark Er. The occurrence of the imaging failure can be easily checked by the display of the error mark Er.

In addition, in a case where a problem such as an imaging failure occurs, a camera icon (second camera icon) of a camera in which the problem has occurred is highlighted and displayed. In the example shown in FIG. 19C, the second camera icon of the second camera C2 is highlighted and displayed (in the present embodiment, displayed in an inverted manner). Accordingly, the camera in which the problem has occurred can be easily identified.

In a case where a problem has occurred, even in the operating status display region 210, a camera icon (first camera icon) of the camera in which the problem occurred is highlighted and displayed (see FIG. 15).

In the captured image display region 220, the position information PP is updated and displayed in accordance with movement of the cart 2. Accordingly, the current position can be checked.

The above example is an example in a case where a captured image is determined to be an imaging failure, but in a case where the remaining level of a battery mounted on each of the cameras C1 to C9 is equal to or less than the threshold value, a camera icon and remaining battery level information of a camera of which a remaining battery level is equal to or less than the threshold value are highlighted and displayed. In a case where imaging cannot be performed due to battery depletion, a captured image cannot be acquired. Therefore, the error mark Er is displayed at the corresponding position as in a case where the captured image is determined to be the imaging failure.

As in a case where communication is not possible, a camera icon of a camera that cannot communicate is highlighted and displayed. In a case where communication is not possible, a captured image cannot be acquired. Therefore, the error mark Er is displayed at the corresponding position as in a case where the captured image is determined to be an imaging failure.

In a case where a problem such as an imaging failure has occurred, the user interrupts imaging immediately before a timing of moment when the occurrence of the problem is recognized. Returning to the position where the problem has occurred, the imaging is resumed.

As described above, with the imaging system 1 of the present embodiment, in a case where a target is imaged using the plurality of cameras, the most recent N captured images (six images in the present embodiment) of each camera are output to a display destination in predetermined arrangement. Then, in a case where an imaging failure has occurred, the error mark Er is displayed instead of display of the captured images. Accordingly, the occurrence of the problem can be easily ascertained. In addition, an imaging state of each camera can be easily checked.

In addition, since the captured images of each camera are displayed in arrangement corresponding to the arrangement of the cameras and are displayed in time series order for each camera, a target can be easily identified in a case where an imaging failure has occurred.

In addition, since the error mark Er includes information indicating an imaging position, the imaging position can be easily identified even in a case of reimaging. In particular, in the present embodiment, since the information of the current position of the cart 2 (position information PP) is displayed in the operating status display region 210, the position of the reimaging can be easily identified from the difference. Therefore, for example, even in a case where the cart 2 advances due to inertia after occurrence of an imaging failure, how much the cart 2 needs to return can be easily identified. In addition, since captured images of cameras adjacent to each other and captured images in time series are displayed in the captured image display region 220, these images can be referred to in a case of adjusting the position for reimaging. Accordingly, position adjustment can be easily performed.

### Modification Example

### Still Image Capturing

Basic processing of still image capturing is the same as in a case of interval imaging except that the user gives an imaging instruction each time. That is, each time imaging is performed, a captured image is output from each of the cameras C1 to C9 to the control device 100. Then, the output image 200 is generated based on the obtained captured image and is output to the display unit 114.

### Motion Picture Imaging

Motion picture imaging is started by an imaging start instruction from the user and is ended by an imaging end instruction.

In a case of motion picture imaging, an image constituting each frame of a motion picture is displayed in the captured image display region 220 as a captured image. In this case, for example, an image is extracted at a predetermined frame interval and is displayed in the captured image display region 220. On the other hand, image determination is performed for each frame. In a case where an imaging failure has occurred, for example, the error mark Er is displayed at a position of a frame scheduled to be extracted immediately after the occurrence.

### Enlarged Display of Captured Image

It is preferable that the captured image imn of each of the cameras C1 to C9, which is displayed in the captured image display region 220 of the output image 200, can be enlarged and displayed.

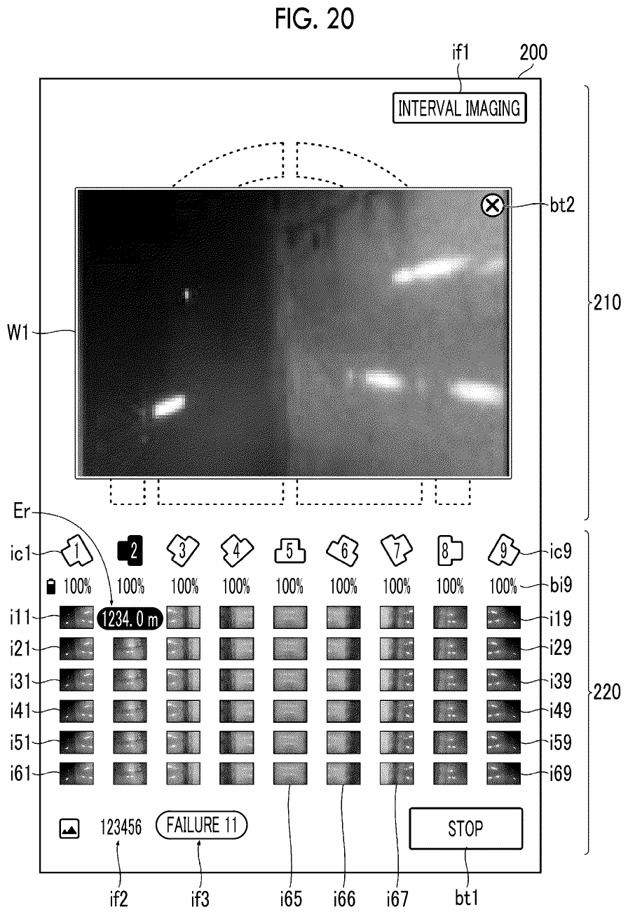

FIG. 20 is a view showing an example of enlarged display.

The user touches and selects a captured image for which enlarged display is desired. In a case where an image is selected, an enlarged display window W1 is displayed to be superimposed on the output image 200, and the selected captured image is enlarged and displayed in the enlarged display window W1.

It is preferable that the captured image enlarged and displayed in the enlarged display window W1 can be further enlarged, reduced, moved, and the like in the enlarged display window W1. An operation of enlarging and reducing is performed by, for example, an operation of pinching out, pinching in, sliding, or the like on the image.

The enlarged display window W1 is deleted from the screen by touching a close button bt2 displayed in the enlarged display window W1. That is, enlarged display is ended.

As described above, with a configuration where a captured image can be enlarged and displayed, for example, an imaging position can be easily checked in a case of reimaging or the like.

### Scroll Display of Captured Image

The captured images imn of each of the cameras C1 to C9 displayed in the captured image display region 220 of the output image 200 may be configured to be displayed by scrolling in a direction (column direction) of arrangement in time series order. Accordingly, the series of captured images can be checked. An operation of scrolling is performed by, for example, a slide operation, a flick operation, and the like on the captured image display region 220.

### Alarm

A configuration where a voice output unit such as a speaker is mounted on the control device 100, and an alarm is generated in a case where an imaging failure or the like has occurred may be adopted. Accordingly, it is possible to make it easier for the user to perceive the occurrence of the problem.

### Automatic Stop of Imaging

In a case of interval imaging, a configuration where imaging is automatically stopped immediately before a timing of moment when an imaging failure has occurred may be adopted.

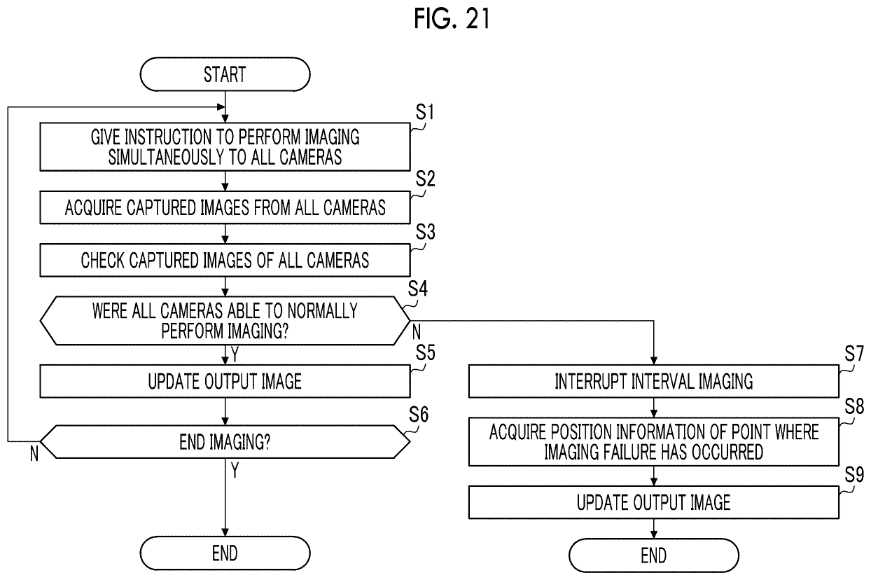

FIG. 21 is a flowchart showing an example of a processing procedure of the control device in a case where imaging is automatically stopped.

The control device 100 gives an instruction to perform imaging simultaneously to all the cameras C1 to C9 in response to an instruction to start imaging from the user (step S1).

The control device 100 acquires images (captured images) obtained by imaging from all the cameras C1 to C9 (step S2).

The control device 100 checks the acquired captured images of all the cameras C1 to C9 (step S3). That is, image quality, overlap ratios, and the like of the captured images are checked.

The control device 100 determines whether or not imaging was able to be normally performed by all the cameras C1 to C9 based on the check results (step S4). That is, whether or not the check results of the captured images of all the cameras C1 to C9 are OK images are determined.

In a case where the imaging could be normally performed by all the cameras C1 to C9, the control device 100 updates the output image 200 (step S5). In this case, the control device 100 updates the output image 200 by using the acquired captured images as the latest captured images. That is, the acquired captured images are disposed at the highest positions in time series arrangement to update the output image 200.

After the output image 200 is updated, the control device 100 determines whether or not imaging end is instructed by the user (step S6). In a case where imaging end is instructed, interval imaging is ended.

On the other hand, in a case where imaging end is not instructed, the imaging is continued. In this case, the processing returns to step S1, and the imaging execution is simultaneously instructed to all the cameras C1 to C9 at the next imaging timing.

In step S4, in a case where it is determined that the imaging could not be normally performed by all the cameras C1 to C9 (in a case where the determination in step S4 is “No”), the control device 100 interrupts the interval imaging (step S7). In a case where the control device 100 comprises the voice output unit such as a speaker, it is preferable to generate an alarm simultaneously with the interruption.

After the imaging is interrupted, the control device 100 acquires position information of the cart 2 at a point where an imaging failure has occurred (step S8) and updates the output image 200 (step S9). The output image 200 in this case is updated to an image including error display. That is, as shown in FIG. 15, a camera icon of the camera in which the imaging failure has occurred is highlighted and displayed, and the error mark Er is displayed at a display position of the captured image. The error mark Er displays the position information of the cart 2 at the point where the imaging failure has occurred.

The user determines a position to perform reimaging from the output image 200 displayed on the display unit 114. Then, the imaging is resumed by returning to the determined position. That is, the start of imaging is instructed.

As described above, the imaging is automatically stopped immediately before a timing of moment when the imaging failure has occurred. Accordingly, the occurrence of overlapping imaging can be suppressed.

The above example is a case of interval imaging, but a configuration of automatic stop can also be applied to a case of motion picture imaging.

### Display Aspect of Captured Image

A configuration where the captured images of the respective cameras C1 to C9 are simply disposed in a matrix is adopted in the above embodiment, but a display aspect of the captured images of the respective cameras C1 to C9 is not limited thereto.

(1) Display with Changed Brightness

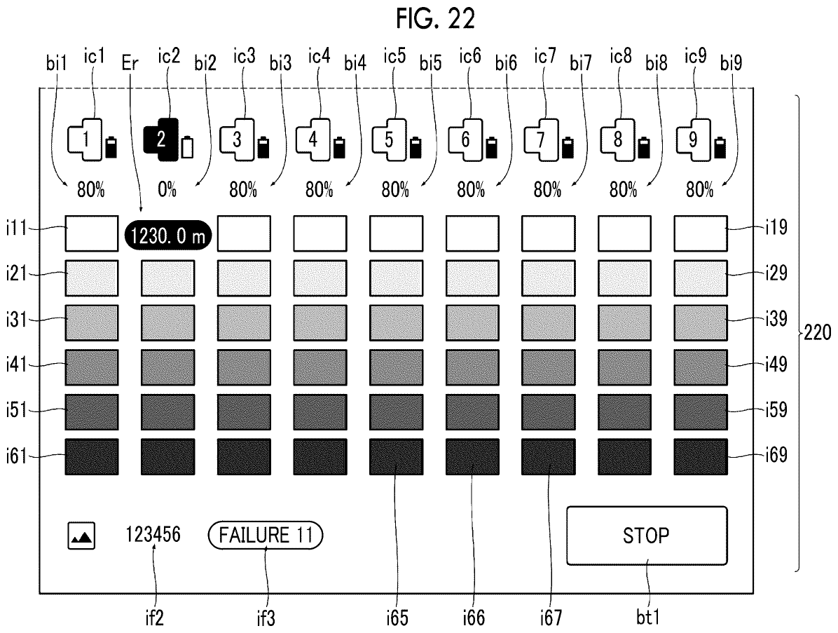

FIG. 22 is a view showing another example of the display of the captured image in the captured image display region.

FIG. 22 shows an example of a case where brightness (lightness) of an image is changed and displayed in the time series direction (column direction). The captured image of each of the cameras C1 to C9 is displayed to be darker as the image is older. Therefore, in the example shown in FIG. 22, the image is displayed darker as the position goes downward. It is preferable that an image to be displayed at the highest position (latest captured image) is displayed without changing the brightness. The images of each column (captured images of each of the cameras C1 to C9) are displayed by gradually decreasing the brightness at a constant ratio from top to bottom, for example, with the image to be displayed at the highest position as reference.

As described above, by displaying images with brightness changed in the time series direction, the latest captured image of each of the cameras C1 to C9 can be easily recognized on the screen. In addition, it can be easily and intuitively recognized that imaging is performed while moving.

A case of changing brightness of an image has been described as an example in the present example, but a configuration where chroma saturation is changed in addition to the brightness or instead of the brightness may be adopted. That is, a configuration where a tone of the image is changed may be adopted.

FIG. 22 also shows another example of the camera icons ic1 to ic9. FIG. 22 shows an example of a case where the camera icons ic1 to ic9 of the respective cameras C1 to C9 are configured by combining a figure resembling a camera and a figure resembling a battery. The numbers of the corresponding cameras C1 to C9 are displayed in the figure resembling a camera. The figure resembling a battery also serves as display of a remaining battery level, and internal display changes according to the remaining battery levels of the corresponding cameras C1 to C9.

(2) Display with Changed Size

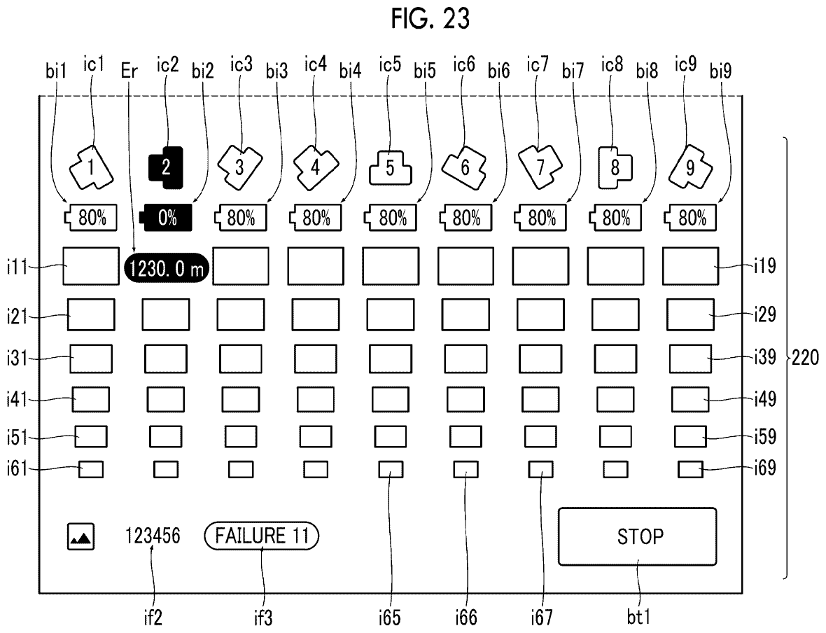

FIG. 23 is a view showing still another example of the display of the captured image in the captured image display region.

FIG. 23 shows an example of a case where a size of an image is changed and displayed in the time series direction (column direction). A captured image of each of the cameras C1 to C9 is displayed to be smaller as the image is older. Therefore, in the example shown in FIG. 23, the image is displayed smaller as the position goes downward. The image in each column is displayed by gradually decreasing in size at a certain ratio from top to bottom, for example, with the image to be displayed at the highest position (latest captured image) as reference.

As described above, by displaying the image with the size changed in the time series direction, the latest captured image of each of the cameras C1 to C9 can be easily recognized on the screen. In addition, it can be easily and intuitively recognized that imaging is performed while moving.

FIG. 23 also shows another example of a display form of the remaining battery level information pieces bi1 to bi9. FIG. 23 shows an example of a case where the remaining battery level is displayed in numerical values in the figure resembling a battery.

(3) Display with Changed Brightness and Size

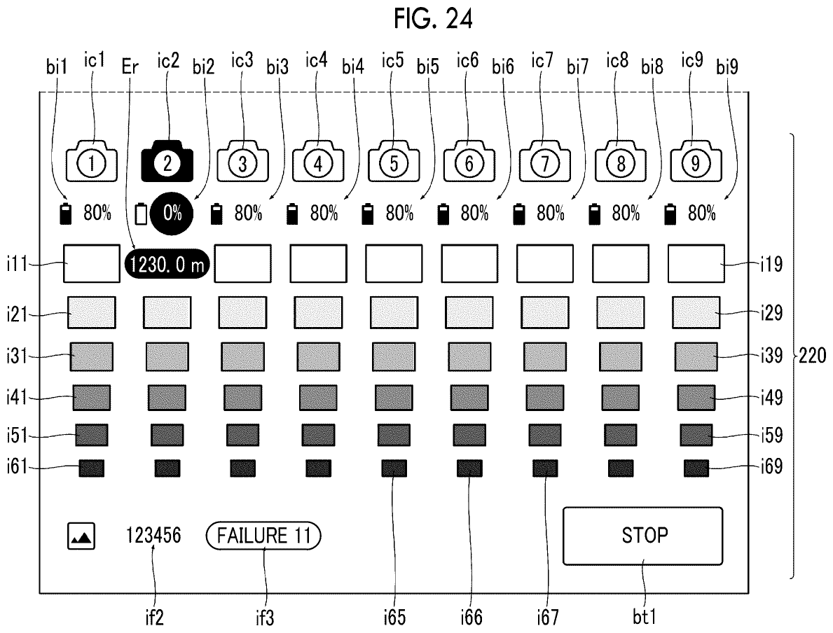

FIG. 24 is a view showing still another example of the display of the captured image in the captured image display region.

FIG. 24 shows an example of a case where brightness and a size of an image is changed and displayed in the time series direction (column direction). The captured image of each of the cameras C1 to C9 is displayed to be darker and smaller as the image is older. Therefore, in the example shown in FIG. 24, the image is displayed to be darker and smaller as the position goes downward.

It is preferable that the image to be displayed at the highest position (latest captured image) is displayed without changing the brightness. The image of each column is displayed by gradually decreasing the brightness at a constant ratio from top to bottom, for example, with the image to be displayed at the highest position as reference. In addition, the image is displayed by gradually decreasing in size at a certain ratio from top to bottom, for example, with the image to be displayed at the highest position as reference.

As described above, by displaying the image with the brightness and size changed in the time series direction, the latest captured image of each of the cameras C1 to C9 can be easily recognized on the screen. In addition, it can be easily and intuitively recognized that imaging is performed while moving.

In addition to the brightness or instead of the brightness, a configuration where the chroma saturation is changed may be adopted. That is, a configuration where a tone of the image is changed may be adopted.

FIG. 24 also shows another example of the camera icons ic1 to ic9 and the remaining battery level information pieces bi1 to bi9. FIG. 24 shows an example of a case where the camera icons ic1 to ic9 of the respective cameras C1 to C9 are configured by combining a figure resembling a camera and a number. An example of a case where the remaining battery level information pieces bi1 to bi9 are displayed by combining figure display and numerical display is shown.

### Display of Error Cause

It is more preferable to have a configuration where in a case where an imaging failure has occurred, a cause of the imaging failure, that is, a cause (error cause) determined as the imaging failure can be notified. For example, a configuration where the error cause is displayed on the screen can be adopted.

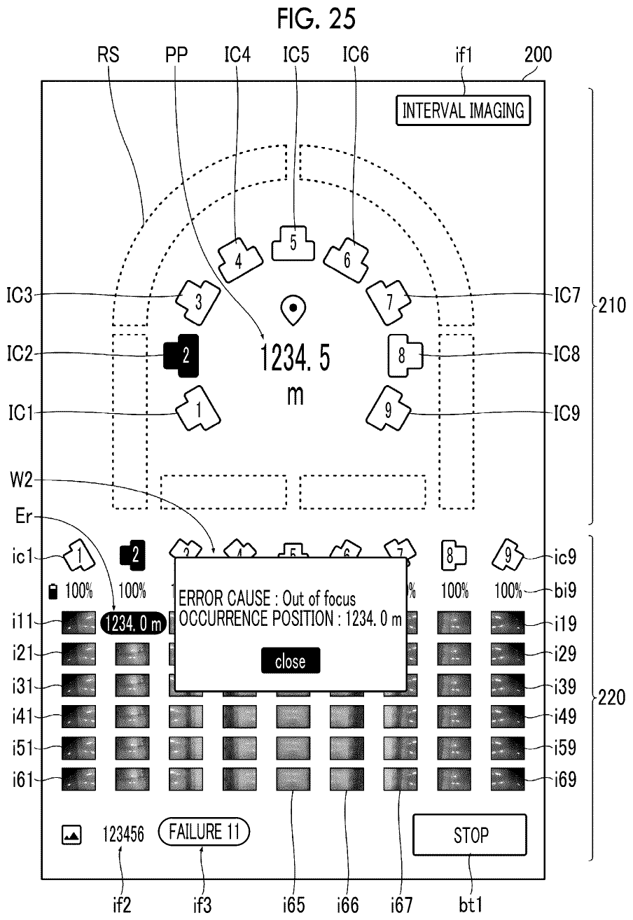

FIG. 25 is a view showing an example of screen display of an error cause.

FIG. 25 shows an example of a case where a predetermined window (error cause display window) W2 is disposed in the output image 200 and an error cause is displayed in the error cause display window W2. In FIG. 25, in addition to the error cause, information on an error occurrence position is also displayed. FIG. 25 shows an example of a case of so-called out of focus. The error cause display window W2 is configured to be displayed in the vicinity of the touched error mark Er, for example, in a case where the error mark Er is touched.

In a case where a captured image is determined to be NG, the image determination unit 111G outputs a determination reason for NG together with the determination result to the output image generation unit 111J. The output image generation unit 111J generates the output image 200 based on the determination reason and displays the output image 200 in the error cause display window W2.

The above example is a case where a determination reason in a case of an imaging failure is displayed as an error cause, but a configuration where a more detailed error cause (an occurrence cause of an error or the like) is estimated and displayed may be adopted. For example, a configuration where an occurrence cause of an imaging failure is estimated from an occurrence status of the imaging failure and is displayed can be adopted.

In general, in imaging while moving, an imaging failure often occurs due to the following causes.

### (1) Case Where Imaging Failure is Single Case

In a case where an imaging failure is a single case, there is a high probability in which there is an occurrence cause of the imaging failure on a subject side. For example, in imaging of the tunnel, as there is an attachment on the inner wall surface of the tunnel, an imaging failure often occurs.

### (2) Case Where Imaging Failure is Continued in Specific Camera

In a case where an imaging failure is continued in a specific camera, there is a high probability in which there is an occurrence cause of the imaging failure in the camera. For example, an imaging failure occurs as dirt, water droplets, and the like adhere to a lens or the camera itself is broken.

### (3) Case Where Imaging Failure Occurs Periodically in Plurality of Cameras

In a case where an imaging failure occurs periodically in the plurality of cameras, there is a high probability in which there is an occurrence cause of the imaging failure on a moving object side. For example, in a case where there is a problem (deformation, blur, or the like) in the wheels of the cart, the imaging failure occurs periodically in the plurality of cameras.

The control device 100 estimates an occurrence cause of an error from the history of a determination result of an image from the image determination unit 111G and outputs the estimation result. For the estimation, for example, a trained model that has been subjected to machine learning to estimate the occurrence cause of the error from the history of the determination result of the image can be used.

In addition, in a case where an occurrence cause of an error is estimated and output, it is preferable to output a countermeasure as well. For example, in a case where it is estimated that an imaging failure has occurred due to dirt on a lens, wiping the lens can be presented as a countermeasure. In addition, in a case where it is estimated that an imaging failure has occurred due to a moving object, checking of the moving object or the like can be presented.

### Subject

A case where the tunnel 3 is imaged has been described as an example in the above embodiment, but a subject is not limited thereto. A configuration where the cameras are disposed in a layout corresponding to the subject, and a pair of cameras having overlapping imaging regions is included is adopted.

### Moving Object

A case where the hand-pushed cart 2 is used as a moving object that moves the multi-eye imaging apparatus 10 has been described as an example in the above embodiment, but the configuration of the moving object is not limited thereto. A configuration of comprising a power source (having a so-called electric assist function) may be adopted.

In addition, the moving object may be configured to self-travel. In a case of the self-driving configuration, it is preferable to adopt a configuration where imaging is interrupted immediately before a timing of moment when a problem such as an imaging failure has occurred and the movement is stopped. In addition, in this case, a configuration of automatically returning to a point where the imaging failure or the like has occurred may be adopted. Further, a configuration where reimaging is automatically performed and the imaging is resumed may be adopted.

In addition, the moving object may have a configuration of flying (for example, a drone or the like).

### Method of Acquiring Information on Position of Moving Object

In the above embodiment, a configuration where a distance from the starting point is measured to identify a position of the cart (moving object) is adopted, but the method of identifying the position of the moving object is not limited thereto. For example, a configuration where the position of the moving object is identified by using a technique of self position estimation through simultaneous localization and mapping (SLAM) can also be adopted. Since the SLAM technique itself is well-known, detailed description thereof will be omitted. For example, SLAM using light detection and ranging (LiDAR) or laser imaging detection and ranging (LiDAR), SLAM using a camera, or the like can be adopted.

In addition, a configuration where a position of a moving object is measured by a positioning system using a beacon, a global positioning system (GPS), an indoor messaging system (IMES), and Wi-Fi, a positioning system using an ultra-wideband (UWB), or the like may be adopted. In addition, a configuration where various types of sensors such as an acceleration sensor, a magnetic sensor, and an angular speed sensor are installed on the movable object, and the position of the moving object is estimated based on values obtained from the respective sensors may be adopted.

### System Configuration

The multi-eye imaging apparatus 10 and the control device 100 can also be configured to be connected through a network such as the Internet in a communicable manner.

In addition, functions of the control device can also be realized by a so-called cloud computer. In this case, for example, a terminal (a personal computer, a smartphone, a tablet, or the like) owned by the user can be used as an input device, and a display of the terminal can be used as a display destination.

### Hardware Configuration of Image Processing Apparatus

Functions of the image processing apparatus are realized by various types of processors. The various types of processors include a CPU and/or a graphics processing unit (GPU) which is a general-purpose processor executing a program and functioning as various types of processing sections, a programmable logic device (PLD) which is a processor of which a circuit configuration can be changed after manufacture, such as a field-programmable gate array (FPGA), and a dedicated electrical circuit which is a processor having a circuit configuration designed exclusively for executing specific processing such as an application-specific integrated circuit (ASIC). The program is synonymous with software.

One processing section may be composed of one of the various types of processors or may be composed of two or more processors of the same type or different types. For example, one processing section may be composed of a plurality of FPGAs or a combination of a CPU and an FPGA. In addition, one processor may constitute a plurality of processing sections. As an example in which a plurality of processing sections constitute one processor, first, there is a form in which one processor is composed of a combination of one or more CPUs and software as typified by a computer used in a client, a server, or the like, and this processor functions as the plurality of processing sections. Second, there is a form in which a processor that realizes functions of an entire system including the plurality of processing sections with one integrated circuit (IC) chip is used, as typified by a system on chip (SoC) or the like. As described above, the various types of processing sections are composed of one or more of the various types of processors used as a hardware structure.

### Supplementary Note

The above modification examples can be used in combination as appropriate.

In addition, in the present specification, meanings of the terms “the same” and “identical” include not only a meaning of “perfectly identical” but also a meaning of “substantially the same” including an error allowed in design and manufacturing. In addition, in the present specification, a meaning of the term “coaxial” includes not only a meaning of “perfectly coaxial” but also a meaning of “substantially coaxial” including an error allowed in design and manufacturing. In addition, in the present specification, a meaning of the term “orthogonal” includes not only a meaning of “perfectly orthogonal” but also a meaning of “substantially orthogonal” including an error allowed in design and manufacturing. In addition, in the present specification, a meaning of the term “parallel” includes not only a meaning of “perfectly parallel” but also a meaning of “substantially parallel” including an error allowed in design and manufacturing. In addition, in the present specification, a meaning of the term “synchronized” includes not only a meaning of “completely synchronized” but also a meaning of “practically synchronized” (a meaning of “substantially synchronized”). In addition, in the present specification, a meaning of the term “simultaneous” includes not only a meaning of “completely simultaneous” but also a meaning of “practically simultaneous” (a meaning of “substantially simultaneous”).

### Explanation of References

1: imaging system
2: cart
3: tunnel
4: rail
5: distance meter
10: multi-eye imaging apparatus
11: frame
12: base
13F: front column
13R: rear column
14F: front panel
14R: rear panel
20: relay device
100: control device
111: processor
111A: camera controller
111B: illumination controller
111C: distance meter controller
111E: data acquisition unit
111E1: image acquisition unit
111E2: status information-acquisition unit
111F: distance information-acquisition unit
111G: image determination unit
111G1: image quality determination unit
111G2: overlap ratio determination unit
111G2a: overlap range detection unit
111G2b: overlap ratio calculation unit
111G2c: overlap ratio acceptability determination unit
111G3: comprehensive determination unit
111H: status determination unit
111J: output image generation unit
111K: output controller
112: main storage unit
113: auxiliary storage unit
114: display unit
115: operator
116: communication unit
200: output image
210: operating status display region
220: captured image display region
Ax: axis of multi-eye imaging apparatus
B1: bracket (first bracket)
B2: bracket (second bracket)
B3: bracket (third bracket)
B4: bracket (fourth bracket)
B5: bracket (fifth bracket)
B6: bracket (sixth bracket)
B7: bracket (seventh bracket)
B8: bracket (eighth bracket)
B9: bracket (ninth bracket)
C1: camera (first camera)
C2: camera (second camera)
C3: camera (third camera)
C4: camera (fourth camera)
C5: camera (fifth camera)
C6: camera (sixth camera)
C7: camera (seventh camera)
C8: camera (eighth camera)
C9: camera (ninth camera)
CL: clamp
Er: error mark
L1: illumination device (first illumination device)
L2: illumination device (second illumination device)
L3: illumination device (third illumination device)
L4: illumination device (fourth illumination device)
L5: illumination device (fifth illumination device)
L6: illumination device (sixth illumination device)
L7: illumination device (seventh illumination device)
L8: illumination device (eighth illumination device)
L9: illumination device (ninth illumination device)
PP: position information
RS: imaging target outline figure
U1: imaging unit (first imaging unit)
U2: imaging unit (second imaging unit)
U3: imaging unit (third imaging unit)
U4: imaging unit (fourth imaging unit)
U5: imaging unit (fifth imaging unit)
U6: imaging unit (sixth imaging unit)
U7: imaging unit (seventh imaging unit)
U8: imaging unit (eighth imaging unit)
U9: imaging unit (ninth imaging unit)
W1: enlarged display window
W2: error cause display window
bi1: remaining battery level information
bi2: remaining battery level information
bi3: remaining battery level information
bi4: remaining battery level information
bi5: remaining battery level information
bi6: remaining battery level information
bi7: remaining battery level information
bi8: remaining battery level information
bi9: remaining battery level information
bt1: imaging stop button
bt2: close button
IC1: camera icon (first camera icon of first camera)
IC2: camera icon (first camera icon of second camera)
IC3: camera icon (first camera icon of third camera)
IC4: camera icon (first camera icon of fourth camera)
IC5: camera icon (first camera icon of fifth camera)
IC6: camera icon (first camera icon of sixth camera)
IC7: camera icon (first camera icon of seventh camera)
IC8: camera icon (first camera icon of eighth camera)
IC9: camera icon (first camera icon of ninth camera)
ic1: camera icon (second camera icon of first camera)
ic2: camera icon (second camera icon of second camera)
ic3: camera icon (second camera icon of third camera)
ic4: camera icon (second camera icon of fourth camera)
ic5: camera icon (second camera icon of fifth camera)
ic6: camera icon (second camera icon of sixth camera)
ic7: camera icon (second camera icon of seventh camera)
ic8: camera icon (second camera icon of eighth camera)
ic9: camera icon (second camera icon of ninth camera)
if1: imaging mode information
if2: total number-of-captured images information
if3: number-of-failure images information
imn (m=1. 2 . . . 6, n=1. 2 . . . 9): captured image

What is claimed is:

1. An image processing apparatus that processes first images captured by a plurality of cameras in time series, the image processing apparatus comprising a processor,
wherein the processor is configured to:
acquire the first images;
acquire first information related to imaging states of the first images;
dispose the most recent N first images of the plurality of cameras in time series order in a case where N≥2 and generate a second image including second information indicating an imaging failure of the first image based on the first information; and
output the second image to a display destination.

2. The image processing apparatus according to claim 1,
wherein the processor is configured to dispose the first images of the plurality of cameras side by side in a first direction and generate the second image in which the most recent N first images of the plurality of cameras are disposed side by side in the time series order in a second direction.

3. The image processing apparatus according to claim 2,
wherein the plurality of cameras are disposed in predetermined arrangement, and
the processor is configured to generate the second image in which the latest first images of the plurality of cameras are disposed side by side in the first direction in arrangement corresponding to the arrangement of the plurality of cameras.

4. The image processing apparatus according to claim 3,
wherein the plurality of cameras are mounted on a moving object to move integrally and capture the first images with movement of the moving object.

5. The image processing apparatus according to claim 4,
wherein the processor is configured to:
acquire third information related to a position of the moving object; and
generate the second image further including the third information.

6. The image processing apparatus according to claim 5,
wherein the third information is information on a distance from a starting point.

7. The image processing apparatus according to claim 5,
wherein the second information includes information related to the position of the moving object at an imaging timing of the first image determined to be the imaging failure.

8. The image processing apparatus according to claim 1,
wherein the processor is configured to generate the second image further including fourth information related to a dispositional relationship between the plurality of cameras.

9. The image processing apparatus according to claim 8,
wherein the fourth information is information on a figure in which a first symbol or a first figure indicating each of the cameras is disposed to correspond to disposition of the plurality of cameras.

10. The image processing apparatus according to claim 9,
wherein the fourth information further includes information on a figure indicating an outline of an imaging target.

11. The image processing apparatus according to claim 9,
wherein the processor is configured to highlight and display the first symbol or the first figure of the camera in which the imaging failure has occurred.

12. The image processing apparatus according to claim 1,
wherein the processor is configured to dispose a second symbol or a second figure indicating each of the cameras and generate the second image in which the most recent N first images of the corresponding camera are disposed in the time series order in association with the second symbol or the second figure.

13. The image processing apparatus according to claim 12,
wherein the processor is configured to highlight and display the second symbol or the second figure of the camera in which the imaging failure has occurred.

14. The image processing apparatus according to claim 1,
wherein the processor is configured to:
acquire fifth information related to states of the plurality of cameras; and
generate the second image further including the fifth information of the plurality of cameras.

15. The image processing apparatus according to claim 14,
wherein the fifth information includes information on a remaining battery level.

16. The image processing apparatus according to claim 14,
wherein the processor is configured to generate the second image in which the most recent N first images of the corresponding camera are disposed in the time series order in association with the fifth information of the plurality of cameras.

17. The image processing apparatus according to claim 1,
wherein the processor is configured to generate the second image in which the most recent N first images of the plurality of cameras are disposed in the time series order with at least any one of a size or a tone changed.

18. The image processing apparatus according to claim 1,
wherein the processor is configured to analyze the first images and acquire the first information.

19. The image processing apparatus according to claim 1,
wherein the processor is configured to:
estimate a cause of the imaging failure based on the first information; and
generate the second image further including an estimation result of the cause of the imaging failure.

20. An image processing method of processing first images captured by a plurality of cameras in time series, the image processing method comprising:
acquiring the first images;
acquiring first information related to imaging states of the first images;
disposing the most recent N first images of the plurality of cameras in time series order in a case where N≥2 and generating a second image including second information indicating an imaging failure of the first image based on the first information; and
outputting the second image to a display destination.

21. A non-transitory, computer-readable tangible recording medium which records thereon an image processing program that processes first images captured by a plurality of cameras in time series, the image processing program causing, when read by a computer, the computer to realize:
a function of acquiring the first images;
a function of acquiring first information related to imaging states of the first images;
a function of disposing the most recent N first images of the plurality of cameras in time series order in a case where N≥2 and generating a second image including second information indicating an imaging failure of the first image based on the first information; and
a function of outputting the second image to a display destination.
